(19) United States
(12) Patent Application Publication
(10) Pub. No.: US 2024/0093033 A1
(43) Pub. Date: Mar. 21, 2024

(54) PAVING COMPOSITIONS AND METHODS OF MAKING THE SAME

(71) Applicant: HONEYWELL INTERNATIONAL INC., Charlotte, NC (US)

(72) Inventors: Yonghong RUAN, Wayne, NJ (US); Swapnil KANAUJIA, Haryana (IN); Scott HACKER, River Edge, NJ (US); Anand Shankar S. MAHADWARE, Haryana (IN)

(73) Assignee: HONEYWELL INTERNATIONAL INC., Charlotte, NC (US)

(21) Appl. No.: 18/464,395

(22) Filed: Sep. 11, 2023

Related U.S. Application Data
(60) Provisional application No. 63/375,721, filed on Sep. 15, 2022.

(51) Int. Cl. C08L 95/00; C08J 3/00; C08J 3/20; C08K 3/32; C08L 23/06

(52) U.S. Cl. CPC C08L 95/00; C08J 3/005; C08J 3/201; C08K 3/32; C08L 23/06; C08J 2323/06; C08J 2423/30; C08J 2491/06; C08J 2495/00; C08K 2003/329; C08L 2205/025; C08L 2205/035; C08L 2207/062; C08L 2207/20

(57) ABSTRACT

Paving compositions and method of producing the same are provided. In an exemplary embodiment, a paving composition includes a binder, where the binder includes bitumen, recycled plastic, and a performance enhancement additive. The performance enhancement additive is selected from the group of low molecular weight polyolefin, a glycidyl compound, and a combination thereof. The low molecular weight polyolefin has a weight average molecular weight of from about 500 to about 30,000 Daltons. The glycidyl compound includes an ethylene glycidyl (meth)acrylate polymer with a weight average molecular weight of from about 500 to about 30,000 Daltons.

### TECHNICAL FIELD

The present disclosure generally relates to paving compositions and methods of making the same. More particularly, the paving compositions comprise bitumen and recovered plastic, where performance enhancement additives facilitate incorporation of recovered plastic into the paving composition.

### BACKGROUND

In 2015, the United States generated 34.5 million tons of waste plastic, and 9.1 percent of that waste plastic was recycled. In 2018, the United States generated 38.5 million tons of waste plastic, and 4.4 percent of that was recycled. The projected numbers for 2019 were 40 million tons of plastic waste with a 2.9 percent recycling rate. The Plastics Industry Association is leading an effort to identify end markets for recycled plastic. Their marketing research report indicates the U.S. asphalt market is large enough to absorb all recyclable polyethylene film in the United States. One of the major challenges to recycling polyethylene film in bitumen binders used in asphalt is poor storage stability of the bitumen binder that includes the recycled polyethylene. This poor storage stability dramatically limits the application of recycled plastic in asphalt.

Accordingly, it is desirable to find materials and processes that improve the storage stability of bitumen binders that include recycled waste polyethylene. In addition, it is desirable to find materials and processes for incorporating waste plastics in asphalt compositions. Furthermore, other desirable features and characteristics of the present embodiment will become apparent from the subsequent detailed description and the appended claims, taken in conjunction with this background.

### BRIEF SUMMARY

Paving compositions and method of producing the same are provided. In an exemplary embodiment, a paving composition includes a binder, where the binder includes bitumen, recycled plastic, and a performance enhancement additive. The performance enhancement additive is selected from the group of low molecular weight polyolefin, a glycidyl compound, and a combination thereof. The low molecular weight polyolefin has a weight average molecular weight of from about 500 to about 30,000 Daltons. The glycidyl compound includes an ethylene glycidyl (meth)acrylate polymer with a weight average molecular weight of from about 500 to about 30,000 Daltons.

A method of preparing a paving composition is provided in another embodiment. The method includes preparing a binder comprising bitumen, a performance enhancement additive, and a recycled plastic. The performance enhancement additive is melted into the binder and is selected from the group of a low molecular weight polyolefin, a glycidyl compound, and a combination thereof. The low molecular weight polyolefin has a weight average molecular weight of from about 500 to about 30,000 Daltons. The glycidyl compound includes an ethylene glycidyl (meth)acrylate polymer with a weight average molecular weight of from about 500 to about 30,000 Daltons. The recycled plastic is also melted into the binder. The binder is mixed with an aggregate to produce the paving composition, where the aggregate is a solid material that may be differentiated from the binder by inspection.

Another paving composition is provided in yet another embodiment. The paving composition includes a binder, an aggregate, and a performance enhancement additive. The binder is present in an amount of from about 1 to about 15 weight percent, based on a total weight of the paving composition, and comprises bitumen. The aggregate is present in an amount of from about 85 to 99 weight percent, where the aggregate is a solid material that can be differentiated from the binder by inspection. The aggregate comprises from about 1 to 100 weight percent waste plastic, based on a total weight of the aggregate. The performance enhancement additive is selected from the group of a low molecular weight polyolefin, a glycidyl compound, and a combination thereof. The low molecular weight polyolefin has a weight average molecular weight of from about 500 to about 30,000 Daltons, wherein the glycidyl compound includes an ethylene glycidyl (meth)acrylate polymer, and wherein the ethylene glycidyl (meth)acrylate polymer has a weight average molecular weight of from about 500 to about 30,000 Daltons.

### BRIEF DESCRIPTION OF THE DRAWINGS

The present embodiments will hereinafter be described in conjunction with the following drawing figures, and wherein:

FIGS. 1 through 4 are photos of aggregate with bitumen coverage, where FIGS. 1 and 2 include 100% bitumen and FIGS. 3 and 4 include 97% bitumen and 3% low molecular weight oxidized polyethylene.

### DETAILED DESCRIPTION

The following detailed description is merely exemplary in nature and is not intended to limit the various embodiments or the application and uses of the embodiments described herein. Furthermore, there is no intention to be bound by any expressed or implied theory presented in the preceding technical field, background, brief summary, or the following detailed description.

In general, recovered plastic may be included in asphalt compositions in two different manners. In one manner, recycled plastic is melted into a molten binder, and becomes part of the binder. This is referred to herein as a “wet” process, and the recovered plastic used in the wet process is referred to as “recycled plastic.” Alternatively, a waste plastic is added to the asphalt composition as a solid, where the binder flows around the waste plastic but does not significantly melt the waste plastic such that the particulate waste plastic remains separately identifiable from the binder in the asphalt composition. This is referred to herein as a “dry” process, and the recovered plastic used in the dry process is referred to herein as “waste plastic” to differentiate the use of the recovered plastic. It is also possible to use both the wet and dry processes at the same time. Both recycled plastic and waste plastic are recovered plastic that has previously been used, such as by consumers or used industrially, or plant scrap. After use, the recovered plastic is recovered for re-use and recycling. Recovered plastic may be washed and/or sorted before reuse in some embodiments. As used herein, an “asphalt composition” is a general term that includes compositions comprising bitumen.

Techniques for increasing the storage stability of asphalt compositions that include recovered plastic are provided. The recovered plastic can be included in a wet process, a dry process, or both. In the wet process, bitumen and recycled plastic are melted together to form a binder, where a performance enhancement additive is used to increase the storage stability of the binder. The performance enhancement additive provides other benefits as well, such as an increase in the PG grade for paving composition, easier compaction, bitumen content reduction for reduced costs, and higher mechanical strength, when compared to comparable compositions that do not include the performance enhancement additive.

The performance enhancement additive is selected from one or both of two components: (1) a low molecular weight polyolefin with a weight average molecular weight of from about 500 to about 30,000 Daltons; and (2) a glycidyl compound, where the glycidyl compound comprises ethylene glycidyl (meth)acrylate polymer with a weight average molecular weight of from about 500 to about 30,000 Daltons. The performance enhancement additive allows for incorporation of higher concentrations of the recycled plastic into the binder, and also increases the stability of the binder with the recycled plastic. Waste plastic is used as a component of aggregate, or as all of the aggregate, in the dry process, where the binder is added to solid aggregate to form the asphalt composition. The performance enhancement additive increases the density of the asphalt composition because of greater compaction with fewer and/or smaller air voids. The performance enhancement additive also increases the aggregate coverage by the binder, resulting in reduced moisture susceptibility of the asphalt composition, such that the resulting composition produces better pavement or waterproofing compositions.

Asphalt compositions described herein may be used for a variety of purposes. In some embodiments, the asphalt compositions are intended for use in road construction or other paving purposes, and most of the following description is directed towards such paving asphalt compositions. Asphalt compositions intended for road construction or paving purposes are referred to herein “paving compositions.” However, the asphalt compositions described herein may also be used for roofing materials, including asphalt shingles and asphalt roofing membranes. The asphalt compositions may also be used for certain waterproofing products, such as waterproof membranes suitable for application to bridges, parking structures, promenade decks, pedestrian trails, bicycle trails, crawl space barriers, below grade structures, etc. Asphalt compositions intended for use as a waterproofing material are referred to herein as “waterproof compositions.” The concentration of the bitumen, the performance enhancement additive, the recovered plastic, the aggregate, and other components may vary for different uses, but the inclusion of recovered plastic with increased storage stability is a benefit for all such asphalt compositions.

Paving compositions for paving purposes generally include two primary components; a binder, and aggregate. The binder generally incorporates bitumen, and the aggregate historically has primarily incorporated minerals, such as crushed stone, sand, gravel, dust, slag, and various recycled materials, where the recycled materials historically have not included waste plastic.

### Aggregate

The term “aggregate,” as used herein, includes components that can be differentiated from the binder by inspection, such that the binder serves to bind and connect the aggregate. As such, crushed stone, gravel, slag, rocks, dust, sand, various recycled materials, and other components that do not melt into the binder are grouped together within the meaning of the term “aggregate.” Differentiation by inspection includes close inspection, such that dusts and fine particles are included within the definition of aggregate. However, inspection does mean a visual inspection, and an inspection unadded by lenses, such as a microscope. The term “filler” has been used to describe rock dust, lime, and other fine particulate material that may optionally be included in paving compositions, and these filler materials are included within the definition of “aggregate” in this description such that a filler material is a subset of aggregate. The aggregates composition, shapes, sizes and quantities are typically chosen such that they conform to various hot mix designs, such as Superpave, Marshall, Hveem and others known in the art.

The aggregate may include waste plastic. In an exemplary embodiment, the aggregate includes waste plastic in an amount of from about 0 to 100 weight percent, based on a total weight of the aggregate. In alternate embodiments, the aggregate may include the waste plastic in an amount of from about 1 to about 100 weight percent, or from about 5 to about 70 weight percent, or from about 5 to about 40 weight percent, based on the total weight of the aggregate. In general, a paving material includes aggregate with various size categories. The particle size distribution of aggregate, or gradation, is one of the most critical characteristics in determining how the paving material will perform. The aggregate can be used for various gradation, including dense gradation, gap gradation, open gradation, uniformed gradation, fine gradation, coarse gradation, etc., or combinations of these gradations. In an exemplary embodiment, large mineral aggregate particles (i.e., larger than about 5 millimeters (mm)) may be replaced by waste plastic to produce an aggregate with about 60 weight percent waste plastic particles having a particle size of from about 5 to about 6 mm, and may also include about 40 weight percent fine aggregates with a particle size of from about 0.15 to about 5 mm, and may also include up to about 3 weight percent filler (such as lime) with an average particle size of from about 0.01 to about 1 mm, based on a total weight of the aggregate. Embodiments that include both mineral aggregate and waste plastic aggregate may have mineral aggregate with a first particle size, and the waste plastic may have a different particle size or the same particle size.

In another exemplary embodiment, large mineral aggregate particles (i.e., greater than about 10 mm) may be replaced by waste plastic to produce an aggregate with about 9 weight percent waste plastic particles having a particle size of from about 5 to about 6 mm, and may also include about 10 weight percent aggregate with a particle size of about 11 mm. This aggregate may also include about 32 weight percent aggregate with a particle size of about 6.3 mm, about 46 weight percent fine aggregates with a particle size of from about 0.15 to about 5 mm, and up to about 3 weight percent filler (such as lime) with an average particle size of from about 0.01 to about 1 mm, based on a total weight of the aggregate.

In an alternative embodiment, the waste plastic and mineral aggregate are mixed at a temperature greater than a melting point of the waste plastic. In this embodiment, the molten waste plastic coats the mineral aggregate to form a coated aggregate with waste plastic substantially surrounding and encasing the mineral aggregate. The waste plastic may not entirely encase the mineral aggregate, such that some portion of the mineral aggregate may be exposed in some embodiments.

### Bitumen

Bitumen is a component of the binder. The term “bitumen,” as used herein, is as defined by the ASTM and is a dark brown to black cement-like material in which the predominant constituents are bitumens that occur in nature or are obtained in petroleum processing. Bitumens characteristically contain saturates, aromatics, resins and a sphaltenes. The terms “asphalt” and “bitumen” are often used interchangeably to mean both natural and manufactured forms of the material, which are all within the scope of the compositions and methods contemplated and described herein.

The type of bitumen suitable for use in the compositions and methods contemplated and described herein are not particularly limited and include any naturally occurring, synthetically manufactured and modified bitumens known now or in the future. Naturally occurring bitumen is inclusive of native rock asphalt or bitumen such as Buton asphalt, a uintaite material, lake asphalt, and the like. Synthetically manufactured bitumen is often a byproduct of petroleum refining operations and includes air-blown bitumen, blended bitumen, cracked or residual bitumen, petroleum bitumen, propane bitumen, straight-run bitumen, thermal bitumen, and the like. A bitumen-based binder includes some type of bitumen (e.g., neat or unmodified bitumen that can be naturally occurring or synthetically manufactured) and may be modified with elastomers, processing oils, tackifiers, phosphoric acid, polyphosphoric acid, plastomers, ground tire rubber (GTR), reclaimed asphalt pavement (RAP), reclaimed asphalt shingles (RAS), and other materials, or various combinations of these modifiers.

Furthermore, industry-grade bitumen, including without limitation, paving-grade bitumen, are advantageous for use in the compositions and methods contemplated and described herein. Non-exclusive examples of paving-grade bitumens include, but are not limited to, bitumens (or asphalts) having any one of the following performance grade ratings: PG 46-40, PG 46-34, PG 52-40, PG 52-34, PG 52-28, PG-58-40, PG 58-34, PG 58-28, PG 64-40, PG 64-34, PG 64-28, PG 64-22, PG 64-16, PG 64-10, PG 67-22, PG 70-40, PG 70-34, PG 70-28, PG 70-22, PG 70-16, PG 70-10, PG 76-34, PG 76-28, PG 76-22, PG 76-16, PG 76-10, PG 82-22, PG 82-16, PG 82-10, PG 88-22, PG 88-16, and PG 88-10. Additionally, non-exclusive examples of paving-grade bitumens within the scope of the present disclosure include, but are not limited to, paving-grade bitumens (or asphalts) having any one of the following penetration grades: 50/70, 60/70, 60/90, 70/100, 80/110, 120/150, 150/180, 150/200, 160/220, 200/300, and 300+ dmm penetration.

It is contemplated that industry-grade bitumen, such as roof-grade asphalt or bitumen, may be advantageously used in the waterproof compositions contemplated and described herein. In such embodiments, the binder compositions will be useful for roofing applications or other waterproofing applications. Suitable roofing-grade bitumens include, but are not limited to, bitumens having any one of the following hardness grades: 50/70 deci-millimeters penetration (dmm pen), 60/90 dmm pen, 70/100 dmm pen, 80/110 dmm pen, 120/150 dmm pen, 100/150 dmm pen, 150/200 dmm pen, 200/300 dmm pen, and 300+ dmm pen. Hardness grades are determined per the test method described in ASTM D5. In some embodiments of the waterproof composition, the bitumen is present at a concentration of from about 40 to about 98 weight % (wt. %), based on the total weight of the waterproof composition. Bitumen may be present at different concentrations in the different waterproof binder compositions described herein (i.e., the binder compositions useful for (i) self-adhering membranes, (ii) shingles, or (iii) other waterproof compositions.) For example, in the binder useful for self-adhering membranes, the bitumen may be present at a concentration of from about 50 to about 60 wt. %, or from about 51 to about 57 wt. %, or from about 53 to about 55 wt. %. In the binder useful for shingles, the bitumen may be present at a concentration of from about 20 to about 50 wt. %, or from about 25 to about 40 wt. %, or from about 30 to about 35 wt. %. Other concentrations may be useful for different waterproofing products.

### Recovered Plastics

The recovered plastic can include many types of plastic. For example, the recovered plastic may include, but is not limited to, one or more of polystyrene, polyolefin, polyvinyl chloride, polymers made from ethylene propylene diene monomer, ethylene vinyl acetate, polyester, polytetrafluoroethylene, polyurethane, polycarbonates, polyamides, polyimides, polyacrylamide, polymethacrylamide, and others. The recovered plastic may be washed before use, such as to remove residue from the previous use of the plastic and be subjected to sorting or other processes. The recovered plastic may be chopped, shredded, crushed, pelletized, or otherwise processed to produce a desirable size and shape for further processing.

Recovered plastics may include the plastics enumerated with numbers for recycling. The classes of these plastics are listed below, and these classes may form some or all of the recovered plastics in an exemplary embodiment. However, it is also possible that alternate sources or recovered plastics are used.

### Classes of Plastics.

There are many different types and varieties of plastics, and many are recyclable. The Society of Plastics Industry (SPI) have established a classification system, as follows:
Class 1: Polyethylene terephthalate (PET) and polyethylene terephthalate ester (PETE), more commonly known as “polyester.” PETE fibers are made under the trade names of DACRON® (E.I. Dupont de Nemours & Co., Wilmington, Del., USA) and FORTREL® (Wellman, Inc., Fort Mill, S.C., USA). PETE film is known commonly as MYLAR® (E.I. Dupont de Nemours & Co., Wilmington, Del., USA). Many food items are packaged in PETE and most of the transparent and colored 2-liter beverage bottles sold in grocery stores are made from PETE, with the exception of opaque bases which are typically made from High Density Polyethylene (HDPE).
Class 2: High density polyethylene (HDPE). HDPE is used for plastic milk bottles, water bottles, cosmetics containers, most plastic grocery bags, and trash bags.
Class 3: Polyvinyl chloride (PVC). Most of the PVC that is produced is used in the manufacture of plastic pipe and conduit. PVC is also used to produce vinyl siding, and vinyl window and door frames. PVC is also used to encase many items such as tools and toys, and is still used to produce plastic bottles. PVC may be made pliable with the addition of phthalate ester and then used to make raincoats, shower curtains, and rubber boots.
Class 4: Low density polyethylene (LDPE). LDPE is used in the manufacture of light weight plastic films, and for food and sandwich bags.
Class 5: Polypropylene (PP). Most PP is used in the production of auto and truck interiors such as door and instrument panels, although some is used in the food packaging. Another important use is in fibers for clothing and carpets.
Class 6: Polystyrene (PS). Polystyrene is used to produce polystyrene foams, which is used in packing, insulation, and food wraps. PS is also used for food containers that are clear, thin, and rigid, such as containers for salads and bakery goods. Many household items, including broom handles, television cases, computer cases, and dry cosmetic containers, are produced from PS.
Class 7 covers any plastics that do not fall in any of Classes 1 through 6. These include polytetrafluoroethylene (PTFE), polyurethane (PU), polycarbonates (PC), polyamides (PA) such as nylon, and the polyacrylamides and polymethacrylamides (PMA) used as an absorbent in diapers and potting soils.

### Waste Plastics

The waste plastic used as aggregate in a paving composition may include unsorted plastics or sorted plastics. The paving composition may provide adequate performance and durability with a wide variety of different types of plastics, and the different types of plastics can be mixed or combined in almost any manner. For example, the waste plastic aggregate in one portion of the paving composition may predominately include one type of plastic, and the waste plastic aggregate in another portion of the same paving composition may predominantly include a different type of plastic, or different mixture to types of plastics. As such, unsorted waste plastic may be used for the aggregate in paving compositions, so the cost of sorting can be avoided. However, sorted waste plastic may be used in alternate embodiments.

The waste plastic used as aggregate may be formed into a desired size, and a wide variety of techniques can be employed to form the aggregate into a desired size. If the waste plastic is too large, it can be reduced in size by chopping, shredding, pulverizing, or other techniques. If the waste plastic is too small, it can be pelletized or agglomerated by melting, partial melting, or compaction. For example, the waste plastic used as aggregate may be formed into a material with an average particle size of from about 20 to about 25 mm, but other average particle sizes are also possible. In alternate embodiments, the average particle size of the waste plastic may be about 20 mm, or about 10 mm, or about 6-7 mm, or other sizes. In some embodiments, the waste plastic may have a broad range of particle sizes, with some particles being larger than others.

The replacement of mineral aggregate with waste plastic has the additional advantage of reducing the total weight of the asphalt composition. For example, a standard paving composition includes about 88 weight percent mineral aggregate and about 12 weight percent bitumen, based on a total volume of the paving composition. A hypothetical paving composition including about 12 volume percent bitumen and about 88 volume percent waste plastic aggregate, based on the total volume of the paving composition, would be about 62% lighter than the same volume of the standard paving composition with about 88 volume percent mineral aggregate. In an exemplary embodiment of a paving composition, the coarse mineral aggregates (20 mm, 10 mm and 6.3 mm) were replaced with waste plastic aggregate (5-6 mm) on a volume basis, and the paving composition with the waste plastic aggregate was about 32% lighter than the standard paving composition with the coarse mineral aggregates. In a hypothetical example, replacing the mineral aggregate granules of architectural roofing shingles with waste plastic aggregate granules on a volume basis would be able to reduce the weight of the architectural roofing shingles by about 22%. The reduction of weight of the paving composition can aid in transport issues, as well as providing other benefits. The reduction of weight of shingles reduces the load on a roofing structure, and similar advantages can apply to other waterproof structures.

### Recycled Plastic

Recycled plastic is melted and incorporated into the binder with bitumen. The particle size of the recycled plastic may vary widely because the particles will be melted for incorporation into the binder. The recycled plastic tends to reduce the storage stability of the binder, as determined by ASTM D7173, and testing has shown that some types of recycled plastic reduce the stability of the binder more than others. For example, recycled low density polyethylene can be incorporated into the binder to form a stable product at a concentration of up to about 4 weight percent of the binder, based on the total weight of the binder. However, polypropylene or other types of plastic may require even lower concentrations to form a stable binder, or may not form a stable binder at any concentration. Therefore, the recycled plastic used for melting and incorporation into the binder may be sorted, such that the recycled plastic is about 50 weight percent or more polyethylene in one embodiment, based on a total weight of the recycled plastic. In alternate embodiments, the recycled plastic incorporated into the binder may be 70 weight percent polyethylene, or 80 weight percent polyethylene, or 90 weight percent polyethylene, or 95 weight percent polyethylene, or 98 weight percent polyethylene, or even 100 weight percent polyethylene, based on the total weight of the recycled plastic. Gel permeation chromatography may be effective at differentiating the recycled plastic from the performance enhancement additive.

### Performance Enhancement Additive

The performance enhancement additive is incorporated into the binder with the recycled plastic. The performance enhancement additive is selected from a low molecular weight polyolefin, a glycidyl compound, or a combination thereof. The low molecular weight polyolefin has a weight average molecular weight of from about 500 to about 30,000 Daltons, and may be referred to as a low molecular weight (LMW) polyolefin. The “low molecular weight polyolefin” as this term is used herein, means an olefin-containing polymer, or a blend of two or more olefin-containing polymers, each of which has a weight average molecular weight (M w) of from about 500 to about 30,000 Daltons, and comprises one or more olefinic monomers, where the olefinic monomers are selected from: ethene, propene, butene, hexene, and octene. Thus, the LMW polyolefins may be homopolymers comprising only a single type of olefin monomer, or copolymers comprising two or more types of olefin monomers. Furthermore, LMW polyolefins, as this term is used herein, include but are not limited to polyolefin waxes, i.e., polyolefins which are solid at or near room temperature and have low viscosity when above their melting point. Some Fischer-Tropsch waxes, i.e., those that satisfy the above-defined characteristics of low molecular weight polyolefins but are produced from carbon monoxide and hydrogen, may also be used in the asphalt compositions contemplated and described herein.

Thermally degraded waxes are also examples of LMW polyolefins, where the thermally degraded waxes have a weight average molecular weight with the limit of from about 500 to about 30,000 Daltons, as mentioned above. The thermally degraded waxes may be formed from virgin polymers or recycled polymers in various embodiments.

The low molecular weight polyolefins may be functionalized in some embodiments, where the low molecular weight polyolefin may be a functionalized homopolymer or a copolymer. In an exemplary embodiment, functionalized low molecular weight polyolefins comprise one or more functional groups including, but not limited to, an acid, an ester, an amine, an amide, an ether, and an anhydride such as maleic anhydride. Additionally, the low molecular weight polyolefins may be oxidized.

In an exemplary embodiment, the LMW polyolefins is an oxidized high density polyethylene. High density polyethylene has a density of from about 0.93 to about 0.97 grams per cubic centimeter (g/cc) or higher, and oxidized high density polyethylene has a density equal to or greater than high density polyethylene depending on the degree of oxidation. An exemplary oxidized high density polyethylene has a density of at least 0.93, 0.94, 0.95, 0.96, 0.97, 0.98, 0.99, or 1.00 g/cc. In contrast, low density polyethylene has a density of from about 0.91 to about 0.93 g/cc. Low density polyethylene tends to include multiple branches in the polymer chain, whereas high density polyethylene has minimal polymer branching. Oxidized polyethylene is a reaction product of polyethylene with oxygen, and may be produced by different techniques. Oxidized polyolefins will have an acid number, defined as the amount of potassium hydroxide in milligrams required to neutralize 1 gram of polyolefin under fixed conditions. One set of fixed conditions, for example, would be ASTM 1386-83.

In an exemplary embodiment, the low molecular weight polyolefin has an olefin content of from about 50 to about 100 wt. %, based on the total weight of the low molecular weight polyolefin. An exemplary low molecular weight polyolefin has an olefin content in wt. %, based on the total weight of the low molecular weight polyolefin, of at least about 55, 60, 65, 70, 75, 80, 85, 90, or 95 wt. %, and independently, of not more than about 100, 98, 95, 92, 90, 85, 80, or 75 wt. %.

As already mentioned, in an exemplary embodiment the low molecular weight polyolefin has a weight average molecular weight (M w) of from about 500 to about 30,000 Daltons. In various embodiments the low molecular weight polyolefin has a M w in Daltons of at least about 500, 1,000, 2,000, 3,000, 4,000, 5,000, 6,000, or 7,000, and independently, of not more than about 30,000, 20,000, 15,000, 12,000, or 10,000. Where the low molecular weight polyolefin comprises a combination of more than one type of polyolefin, the M w of each type of polyolefin in the combination may individually be within the above-stated range of about 500 to about 30,000 Daltons. The weight average molecular weight of the low molecular weight polyolefins of the present disclosure may be determined by gel permeation chromatography (GPC), which is a technique generally known in the art. For the purpose of GPC, the sample to be measured may be dissolved in 1,2,4-trichlorobenzene at about 140° C. and at a concentration of about 2.0 mg/ml. The solution (200 microliters (μL)) is injected into the GPC containing two PLgel 5 micrometer (μm) Mixed-D (300×7.5 mm) columns held at about 140° C. with a flow rate of about 1.0 mL/minute. The instrument may be equipped with two detectors, such as a refractive index detector and a viscosity detector. The molecular weight (weight average molecular weight, Mw) is determined using a calibration curve generated from a set of linear polyethylene narrow Mw standards.

Generally, suitable low molecular weight polyolefins include, without limitation, polyethylene homopolymers, polypropylene homopolymers, copolymers of two or more of ethylene, propylene, butene, hexene and octene, functionalized derivatives of the homopolymers mentioned above, functionalized derivatives of the copolymers mentioned above, or combinations of unfunctionalized and functionalized low molecular weight polyolefins. Some Fischer-Tropsch waxes, i.e., those that satisfy the above-defined characteristics of low molecular weight polyolefins but are produced from carbon monoxide and hydrogen, may also be used in the asphalt compositions contemplated and described herein. Examples of suitable functionalized low molecular weight polyolefins include, without limitation, maleated polyethylene, maleated polypropylene, ethylene acrylic acid copolymers, ethylene vinyl acetate copolymers, oxidized polypropylene, oxidized polyethylene, including oxidized low molecular weight polyethylene, and combinations thereof.

In an exemplary embodiment, the low molecular weight polyolefin is selected from the group of polyethylene, oxidized polyethylene with an acid number of from about 5 to about 40 milligrams potassium hydroxide per gram (mg KOH/gm), polypropylene, maleated polypropylene, and combinations thereof. In alternate embodiments, the low molecular weight polyolefin is polyethylene, or oxidized polyethylene, or polypropylene, or maleated polypropylene, a co-polymer of ethylene and propylene, or combinations thereof.

The glycidyl compound comprises ethylene glycidyl (meth)acrylate polymer. The term “(meth)acrylate,” as used herein, means an acrylate compound that may or may not include a methyl group, so the term includes “ . . . acrylate,” and “ . . . methacrylate.” The ethylene glycidyl (meth)acrylate polymer may include from about 4 to about 20 weight percent glycidyl (meth)acrylate, and from about 80 to about 96 weight percent ethylene in the polymer. However, in an alternate embodiment the ethylene glycidyl (meth)acrylate polymer includes from about 2 to about 30 weight percent glycidyl (meth)acrylate, and from about 70 to about 98 weight percent ethylene. The ethylene glycidyl (meth)acrylate polymer has a weight average molecular weight of from about 500 to about 30,000 Daltons. Binder compositions that include the glycidyl compound often also include polyphosphoric acid as a constituent.

The glycidyl compound may include an ethylene glycidyl (meth)acrylate copolymer, terpolymer, a polymer with more than three monomers, or a mixture of the above compounds. The acrylate compound includes a polymer with more than one monomer in an exemplary embodiment, and the acrylate compound may be free of a homopolymer, where “free” of a homopolymer means the glycidyl compound may include less than about 1 weight percent homopolymer, based on a total weight of the glycidyl compound. Additional monomer(s) in the polymers may include methyl (meth)acrylate, butyl (meth)acrylate, and similar compounds, including combinations thereof. A variety of glycidyl (meth)acrylate based polymers may be effective for improving the storage stability of the binder. As such, the ethylene glycidyl (meth)acrylate polymer may be formed from two or more monomers selected from the group of ethylene, glycidyl acrylate, glycidyl methacrylate, methyl acrylate, methyl methacrylate, butyl acrylate, and butyl methacrylate. The low molecular weight of from about 500 to about 30,000 Daltons is expected to provide improved storage stability as compared to other glycidyl compositions that include ethylene glycidyl (meth)acrylate polymers with molecular weight greater than 30,000 Daltons.

In different exemplary embodiments, the performance enhancement additive includes: the glycidyl compound without the polyolefin; the polyolefin without the glycidyl compound; and a combination of the glycidyl compound and the polyolefin. In exemplary embodiments, the combination of the glycidyl compound and the polyolefin more specifically includes: a combination of oxidized, low molecular weight, high density polyethylene, the glycidyl compound, and polyphosphoric acid; a combination of low molecular weight polypropylene, the glycidyl compound, and polyphosphoric acid; and maleated polypropylene, the glycidyl compound, and polyphosphoric acid. Other specific combinations of the polyolefin and the glycidyl compound are also possible.

### Additives

The asphalt compositions described herein may also include other additives in some embodiments. Additional additives such as plastomers, elastomers, or both are well-known in the industry for use in asphalt compositions including binders, and these additives may expand the temperature ranges at which asphalt compositions can be used without serious defect or failure. Plastomers and elastomers generally are polymers of one type or another, and may be used for asphalt compositions, such as the binder of the paving composition, or for the waterproof composition, or for other purposes. The asphalt compositions contemplated herein may optionally comprise one or more polymers, other than the performance enhancement additive, which are present in a total amount of from about 0.5 to about 30 wt. %, based on the total weight of the asphalt composition. Non-limiting examples of polymers suitable for modifying the asphalt compositions contemplated herein include natural or synthetic rubbers including ground tire rubber (GTR), devulcanized GTR, micronized GTR, butyl rubber, styrene/butadiene rubber (SBR), styrene/ethylene/butadiene/styrene terpolymers (SEBS), polybutadiene, polyisoprene, ethylene/propylene/diene (EPDM) terpolymers, and styrene/conjugated diene block or random copolymers, such as, for example, styrene/butadiene including styrene/butadiene/styrene copolymer (SBS), styrene/isoprene, styrene/isoprene/styrene (SIS) and styrene/isoprene-butadiene block copolymer. The block copolymers may be branched or linear and may be a diblock, triblock, tetrablock or multiblock. The binder may optionally include the polymers listed above, as well as other polymers used to improve performance, in addition to the bitumen, the performance enhancement additive, and the recycled plastic.

The asphalt compositions contemplated herein may include additional additives in some embodiments. The asphalt compositions include the binder of the paving composition as well as the waterproof composition, and also includes other embodiments not specifically described. Non-exclusive examples of such additives suitable for inclusion in the asphalt compositions contemplated and described herein include, without limitation, plastomers, waxes (where the waxes may also be polymers), polyphosphoric acids, flux oils, plasticizers, anti-oxidants, tackifiers, processing aids, UV protecting additives, etc. Exemplary non-exclusive waxes include ethylene bis-stearamide wax (EBS), Fischer-Tropsch wax (FT) (outside the definition of a “polyolefin” provided herein), oxidized Fischer-Tropsch wax (FTO) (outside the definition of a “polyolefin” provided herein), alcohol wax, silicone wax, petroleum waxes such as microcrystalline wax or paraffin, natural waxes, and other synthetic waxes. Exemplary plasticizers include hydrocarbon oils (e.g., paraffin, aromatic and naphthenic oils), long chain alkyl diesters (e.g., phthalic acid esters, such as dioctyl phthalate, and adipic acid esters, such as dioctyl adipate), sebacic acid esters, glycol, fatty acids, phosphoric and stearic esters, epoxy plasticizers (e.g., epoxidized soybean oil), polyether and polyester plasticizers (which may also be polymers), alkyl monoesters (e.g., butyl oleate), long chain partial ether esters (e.g., butyl cellosolve oleate), and others. Exemplary tackifiers include rosins and their derivatives; terpenes and modified terpenes; aliphatic, cycloaliphatic and aromatic resins (C5 aliphatic resins, C9 aromatic resins, and C5/C9 aliphatic/aromatic resins); hydrogenated hydrocarbon resins; terpene-phenol resins; and combinations thereof. Exemplary oils include flux oils (e.g., paraffin, aromatic and naphthenic oils), bio oils, corn oils, soybean oils, tall oils, reclaimed oil, recycled engine oils, recycled engine oil bottom (REOB), and combinations thereof.

In an exemplary embodiment, the asphalt compositions, including the paving composition, the waterproof composition, and other compositions, are free of cement, where “free of cement” means comprising cement in an amount of less than about 0.1 weight percent, based on a total weight of the asphalt composition. This means the binder is also free of cement, such that the binder includes cement in an amount of less than about 0.1 weight percent. Cement, as used herein, includes but is not limited to ordinary portland cement, high-early-strength portland cement, ultra high-early-strength cement, moderate heat portland cement, white portland cement, blast furnace cement, silica cement, alumina cement, expansive cement, blast furnace colloid cement, colloid cement, ultra rapid hardening cement, white cement, fly ash cement, sulfate resisting cement, jet cement, and combinations thereof.

### Binder

The binder includes bitumen, the performance enhancement additive, and recycled plastic, as mentioned above. In exemplary embodiments, the binder includes the performance enhancement additive in an amount of from about 0.1 to about 5 weight percent; and the recycled plastic in an amount of from about 1 to about 20 weight percent, based on the total weight of the binder, as has been mentioned above. For example, the binder may include from about 0.1 to about 5 weight percent low molecular weight polyolefin; and/or from about 0.1 to about 5 weight percent glycidyl compound with about 0.1 to about 1 weight percent polyphosphoric acid, all based on the total weight of the binder. In an alternate embodiment, the binder may include about 0.5 to about 5 weight percent low molecular weight polyolefin, or about 0.5 to about 3 weight percent low molecular weight polyolefin, based on the total weight of the binder. The binder may be free of either the low molecular weight polyolefin or the glycidyl compound in various embodiments, but the binder is not free of both the low molecular weight polyolefin and the glycidyl compound at the same time when in use.

In an exemplary embodiment, the low molecular weight polyolefin and/or the glycidyl compound may be combined with the aggregate, so the binder may be free of the both the low molecular weight polyolefin and the glycidyl compound before being mixed with the aggregate. However, at least some of the low molecular weight polyolefin and/or glycidyl compound is then melted into aggregate in the final paving composition. It is possible that some of the low molecular weight polyolefin and/or glycidyl compound may not melt into the binder, and therefore remain with the aggregate, so the amount of low molecular weight polyolefin and/or glycidyl compound may be increased to ensure enough melts into the binder for the desired performance. The low molecular weight polyolefin may be functionalized in some embodiments, as mentioned above. The binder may also optionally include additives other than the performance enhancement additive and the recycled plastic. The other optional additives may be included in an amount of from 0 to about 30 weight percent, based on the total weight of the binder. The binder includes the bitumen in an amount of from about 25 to about 99.9 weight percent, based on a total weight of the binder. The recycled plastic may also be added to the aggregate as the recovered plastic to form a portion of the enhanced aggregate. Some of the recovered plastic may then melt into the binder, where the recovered plastic that melts into the binder is referred to herein as the “recycled plastic,” as mentioned above. Any of the recovered plastic that does not melt into the binder remains with the aggregate as a waste plastic, and forms a portion of the aggregate in the final paving composition. The “waste plastic” is the term used for recovered plastic that is not melted into the binder and serves as aggregate in the paving composition, as mentioned above.

Binder that includes the recycled plastic, but does not include the performance enhancement additive, tends to be unstable unless the binder includes the recycled plastic at very low concentrations, based on the total weight of the binder. For the low density polyethylene recycled plastic used in this work, 4 weight percent low density polyethylene forms a stable binder, based on the total weight of the binder. If the recycled plastic includes polypropylene or other types of plastic other than low density polyethylene, the binder tends to become unstable at even lower concentrations of the recycled plastic, or may be unstable at all concentrations. The performance enhancement additive increases the amount of recycled plastic that can be incorporated into a stable binder composition. Therefore, in an exemplary embodiment, the binder may include low density polyethylene in an amount of greater than 4 weight percent, based on a total weight of the binder, and wherein the binder also includes the performance enhancement additive. For example, the binder may comprise from about 4 to abut 20 weight percent low density polyethylene, where the polyethylene is a recycled plastic. In another embodiment, the binder includes from about 4 to about 8 weight percent low density polyethylene from the recycled plastic.

### Paving Composition

The paving composition is intended for use for roads, parking lots, driveways, and other similar structures. The paving composition is suitable for sustaining motor vehicle traffic. The paving composition includes the binder and the aggregate as discussed above. The binder is present in the paving composition in an amount of from about 1 to about 15 weight percent, and the aggregate is present in an amount of from about 85 to about 99 weight percent, based on the total weight of the paving composition.

The binder is stable, where a stable binder indicates the top and bottom portions of the binder have about the same softening point. In this description, a “stable binder” is defined by a top sample and a bottom sample which have a softening point difference (absolute value) of 5° C. or less. If the binders' top sample softening point and the bottom sample softening point is within 5° C. of the other, the binder is considered stable, regardless of which of the top and bottom samples have the higher softening point. The top sample and bottom sample of the binder are obtained using a separation test, as described by ASTM D7173. The softening point of the top sample and of the bottom sample are then determined using a ring and ball softening point test, wherein the ring and ball softening point test is described by ASTM D36. The ASTM D7173 separation test, or the “Standard Practice for Determining the Separation Tendency of Polymer from Polymer Modified Asphalt,” provides consistent sampling of the top and bottom portions of an asphalt composition, such as the binder. The ring and ball softening point tests, or ASTM D36, is a consistent method for measuring the softening point of an asphalt composition, such as the binder. Other countries/regions sometimes use other parameters such as G*, complex modulus, to determine storage stability. For example, the specification is delta G*<20% for Qatar national specification. However, for this description, the definition provided above is used. A stable binder is important to produce paving compositions that provide consistent quality for the construction of roads, parking lots, and other structures intended to bear motor vehicles.

Another important parameter for the binder is its workability, processibility, or pumpability, which is determined by the binder's viscosity at or around about 135° C. following ASTM D4402. It is well accepted by the world paving industry that a binder's viscosity at or around 135° C. should be below about 3000 centipoise (cPs) for it to have acceptable workability, processibility, or pumpability. Viscosities above about 3,000 cPs produce a binder with poor workability, processibility, and/or pumpability.

In an alternate embodiment, the paving composition includes the aggregate, where the aggregate includes the waste plastic in an amount of up to 100 weight percent, based on the total weight of the aggregate. For example, the aggregate in the paving composition may include from about 1 to 100 weight percent waste plastic. The paving composition also includes the binder, where the binder comprises the bitumen and the low molecular weight polyolefin of the performance enhancement additive, but the binder may be free of recycled plastic. The binder may also be free of the glycidyl compound. The binder may also include other additives as described above. It has been found that the binder combined with the low molecular weight polyolefin provides better coverage of both the waste plastic aggregate and the mineral aggregate, and produces a denser paving composition, as compared to the same binder without the low molecular weight polyolefin as described for the performance enhancement additive.

Waterproof Compositions

Many different waterproof compositions that incorporate recovered plastic are possible. This includes roofing membranes, shingles, and other waterproof structures. The waterproof compositions comprise a waterproof binder, sometimes a substrate, a surface layer, a back layer, and other optional components. The substrate may be polyester mat, glass fiber mat, glass fiber reinforced polyester mat, or other materials. The surface layer can be a mineral granule, a granule made with one or more of a recovered plastic, sand, talc, paint, plastic film, metal film, etc. the back layer can be sand, talc, plastic film, metal film, etc. The waterproof compositions include a waterproof binder, where the waterproof binder includes bitumen, recycled plastic, the performance enhancement additive, optionally a filler, and optionally other compounds. The waterproof binder includes the recycled plastic in an amount of from about 1 to about 20 weight percent, and the performance enhancement additive in an amount of from about 1 to about 10 weight percent, and the filler in an amount of from 0 to 70 weight percent, based on the total weight of the waterproof binder. The waterproof binder may also include additional additives, other than the recycled plastic and the performance enhancement additive, in an amount of from about 0 to about 40 weight percent, based on the total weight of the waterproof binder. The waterproof compositions may include other components as well. For example, shingles include at least one adhesive. The filler may be limestone, stone dust, fly ash, other materials, or a combination thereof in various embodiments.

### Method of Production of the Paving Composition

The paving composition is produced by mixing the components of the binder to produce the binder, and mixing the binder with the aggregate to produce the paving composition. In particular, the binder can be produced by mixing the bitumen described above, the performance enhancement additive described above, and the recycled plastic described above in a molten state to produce the binder. Other additives (besides the performance enhancement additive and the recycled plastic) may optionally be mixed in with the binder and/or the aggregate in various embodiments. The binder may be mixed at a temperature of from about 90° C. to about 220° C., or in another embodiment the binder may be mixed at a temperature of from about 100° C. to about 190° C. In the “wet” process, the performance enhancement additive and the recycled plastic are melted into the binder. The binder may then be mixed with the aggregate to produce the paving composition.

In the “dry” process, the performance enhancement additive and/or the waste plastic may be mixed with the aggregate to form an enhanced aggregate, and then the enhanced aggregate may be mixed with the binder to form the paving composition. However, in alternate embodiments, the waste plastic and/or the performance enhancement additive may be mixed with the binder prior to mixing the binder and the aggregate. In such cases, recovered plastic is mixed into the paving composition, either with the aggregate, the binder, or separately, and some of the waste plastic melts into the binder and is referred to herein as the “recycled plastic,” as mentioned above. Some of the recovered plastic remains separate and distinguishable from the binder and serves as an aggregate, and is referred to herein as “waste plastic,” also mentioned above. The performance enhancement additive may be mixed with the binder before mixing in the aggregate, but in other embodiments the performance enhancement additive may be included in the enhanced aggregate and then mixed with the binder when the binder and aggregate are combined. As such, some of the performance enhancement additive may be incorporated into the binder, but some may remain distinct from the binder and still serve to stabilize the and improve the performance of the paving composition with the waste plastic as a component of the aggregate. It may be easier for some producers to mix the recovered plastic and/or the performance enhancement additive with the aggregate prior to combining with the binder, depending on the type of equipment utilized.

The aggregate as described above is mixed with the binder to produce the paving composition. In embodiments where the aggregate comprises waste plastic, the aggregate may be mixed with the binder in a manner that prevents or minimizes melting of the waste plastic of the aggregate. This can be accomplished by mixing the aggregate and binder at a temperature lower than the melting point of the waste plastic, or by mixing the aggregate and binder rapidly and then cooling the paving composition such that the waste plastic is not exposed to temperatures above the waste plastic melting point for an extended period. Also, some of the waste plastic may melt during or after the mixing of the aggregate and the binder, because the binder may be able to incorporate some additional plastic material from the waste plastic. Alternatively, some molten waste plastic may remain segregated from the binder in the mixture around the edges of solid waste plastic particles, and the molten waste plastic may then re-solidify as a solid aggregate that can be differentiated from the binder by inspection as the paving composition cools. In an exemplary embodiment, the binder and waste plastic are mixed at a temperature of from about 90° C. to about 220° C., but in an alternate embodiment the binder and aggregate are mixed at a temperature of about 100° C. to about 190° C.

In an alternate embodiment, the method includes mixing the waste plastic with a mineral aggregate at a temperature that exceeds the melting point of the waste plastic. The waste plastic and the mineral aggregate are mixed at conditions effective to coat the mineral aggregate with the waste plastic such that the waste plastic essentially encases the mineral aggregate to form an encased aggregate. The encased aggregate can then be mixed with the binder to form the paving composition. The mineral aggregate may be fully encased in the waste plastic in some embodiments, but in alternate embodiments the mineral may be partially encased. In an exemplary embodiment, from about 20 to 100 percent of the surface area of the mineral aggregate may be encased in waste plastic. However, in alternate embodiments, about 50 to 100% or about 75 to 100% of the surface area of the mineral aggregate is encased with the waste plastic.

### Examples

Several experiments were conducted as documented below.

Table 1 provides 21 binders that were produced and tested as noted below. These tests show the increased storage stability when the performance enhancement additive includes (1) low molecular weight oxidized polyethylene homopolymer, (2) the glycidyl compound, (3) a low molecular weight polyethylene homopolymer, (4) the glycidyl compound combined with polyphosphoric acid and a Fischer-Tropsch wax, and/or (5) a thermally degraded wax. Table 1 provides examples of the “wet” process, where the recycled plastic is melted into the binder. The recycled plastic in the examples described in Table 1 were low density polyethylene. The storage stability is clearly demonstrated in the absolute value (ABS) of the Drop Point Difference (° C. top−° C. bottom), where a difference of greater then 5° C. is considered unstable. Run #14 shows acceptable storage stability when high molecular weight glycidyl compound #2 is used, but the viscosity at 135° C. of 9360 cps is much higher than the 3000 cps maximum. Run #20 shows the glycidyl compound and polyphosphoric acid do not produce stable product when the low density polyethylene recycled plastic concentration reached 8 weight percent, but Runs #5, #6, and #7 show the glycidyl compound and polyphosphoric acid are effective to produce stable product at low density polyethylene recycled plastic concentrations of 7 weight percent.

Blends #1, 2, 4 and 8 produced in Table 1 followed a blending procedure of adding recycled plastic to the molten bitumen @ 180° C. and mixing for 4 hours at around 3500 rpm in a high shear mixer. Blends #9, 16, 17 and 21 were produced by following the blending procedure described above by adding recycled plastic and LMW polyethylene homopolymer to the molten bitumen @ 180° C. and mixing for 4 hours at around 3500 rpm in a high shear mixer. Blend #12 was produced by following the blending procedure described above and by adding recycled plastic and Fischer-Tropsch wax to the molten bitumen @ 180° C. and mixing for 4 hours at around 3500 rpm in a high shear mixer. Blends #3, 5, 6, and 10 were produced by following the blending procedure described above by adding recycled plastics, LMW oxidized polyethylene homopolymer and glycidyl compound to molten bitumen @ 180° C. and mixing for 2 hours around 3500 rpm in a high shear mixer and after completion of 2 hours mixing, then PPA (Poly Phosphoric Acid) was added and mixed for another 2 hours. Blend #11 was produced by following the blending procedure described above by adding recycled plastics, Fischer-Tropsch wax and glycidyl compound to molten bitumen @ 180° C. and mixing for 2 hours around 3500 rpm in a high shear mixer and after completion of 2 hours mixing, then PPA (Poly Phosphoric Acid) was added and mixed for another 2 hours. Blends #7, 13, 14, 15, and 20 were produced by following the blending procedure described above and by adding recycled plastics and glycidyl compound (high or low molecular weight) to molten bitumen @ 180° C. and mixing for 2 hours at around 3500 rpm in a high shear mixer and after completion of 2 hours mixing, then PPA (Poly Phosphoric Acid) was added and mixed for another 2 hours. Blends #18 and 19 were produced by following the blending procedure described above by adding recycled plastic and thermally degraded wax to the molten bitumen @ 180° C. and mixing for 4 hours at around 3500 rpm in a high shear mixer.

TABLE 1
Part 1

| | Temp | | | | | | | |
|---|---|---|---|---|---|---|---|---|
| Component | (° C.) | #2 | #1 | #15 | #4 | #3 | #10 | #11 |
| Bitumen Grade NA PG64-22 | | 96 | 94 | 91.73 | 93 | 91.73 | 91.73 | 91.73 |
| Recycled plastic (low density polyethylene) | | 4 | 6 | 6 | 7 | 6 | 6 | 6 |
| Low mol. wt. oxidized polyethylene | | | | | | 1 | | |
| homopolymer #1 (density = 0.99 g/cc) | | | | | | | | |
| Glycidyl compound | | | | 2 | | 1 | 1 | 1 |
| Polyphosphoric acid | | | | 0.27 | | 0.27 | 0.27 | 0.27 |
| Low mol. wt. polyethylene | | | | | | | | |
| homopolymer #1, (density = 0.93 g/cc) | | | | | | | | |
| Low mol. wt. oxidized polyethylene | | | | | | | 1 | |
| homopolymer #2 (density = 0.96 g/cc) | | | | | | | | |
| Fischer-Tropsch wax | | | | | | | | 1 |
| High mol. wt. glycidyl composition #1 | | | | | | | | |
| High mol. wt. glycidyl composition #2 | | | | | | | | |
| Brooksfield Viscosity (cPs) | 135 | 1010 | 1050 | 1290 | 1130 | 1610 | 1060 | 1510 |
| G* sin(delta) (kPa) | 70 | 1.06 | 1.75 | 2.18 | 1.88 | 3.14 | 2.42 | 3.57 |
| G* sin(delta) (kPa) | 76 | 0.54 | 0.86 | 1.10 | 0.95 | 1.56 | 1.21 | 1.76 |
| Pass/fail temp | (° C.) | 70.5 | 74.4 | 76.8 | 75.5 | 79.8 | 77.7 | 80.8 |
| RTFO Residue | | | | | | | | |
| G* sin(delta) (kPa) | 70 | 2.99 | 4.52 | 6.11 | 4.05 | 8.42 | 5.97 | 8.85 |
| G* sin(delta) (kPa) | 76 | 1.43 | 2.12 | 3.14 | 1.89 | 4.05 | 3.07 | 4.65 |
| Pass/fail temp | (° C.) | 72.5 | 75.7 | 79.2 | 74.8 | 81 | 79 | 83 |
| MSCR on RTFO Residue | | | | | | | | |
| R 3.2 kPa (%) | 70 | 3.11 | 2.12 | 11.28 | 1.45 | 9.08 | 9.12 | 17.3 |
| Jnr 3.2 kPa | 70 | 2.57 | 2 | 1.16 | 2.42 | 0.9 | 1.25 | 0.68 |
| Jnr Diff. | 70 | 15.7 | 15.31 | 44.93 | 12.71 | 46.28 | 58.2 | 75 |
| MSCR on RTFO Residue | | | | | | | | |
| R 3.2 kPa (%) | 76 | 1 | 0.59 | 3.96 | 0.32 | 3.4 | 3.2 | 6.7 |
| Jnr 3.2 kPa | 76 | 5.01 | 4.8 | 2.93 | 5.29 | 2.3 | 3.03 | 1.81 |
| Jnr Diff. | 76 | 17.5 | 17.56 | 48.06 | 12.92 | 52.73 | 59.9 | 88.57 |
| Separation test | | | | | | | | |
| Softening point ° C. | Top | 64 | 55.7 | 55.1 | 54.6 | 67.7 | 63 | 67.7 |
| Softening point ° C. | Bottom | 67.3 | 62.5 | 56.9 | 60.7 | 64.2 | 60.6 | 63.5 |
| ABS (Difference (top-bottom)), ° C. | | 3.3 | 6.8 | 1.8 | 6.1 | 3.5 | 2.4 | 4.2 |
| PG | | 70 | 70 | 76 | 70 | 76 | 76 | 76 |
| PG-MSCR | | 70S | 70H | 70H, | 70S | 70V, | 70H, | 70V, |
| | | | | 76S | | 76S | 76S | 76H |

Part 2

| | Temp | | | | | | | |
|---|---|---|---|---|---|---|---|---|
| Component | (° C.) | #5 | #6 | #7 | #9 | #12 | #13 | #14 |
| Bitumen Grade NA PG64-22 | | 90.73 | 90.73 | 90.73 | 91 | 91 | 90.83 | 90.83 |
| Recycled plastic (low density polyethylene) | | 7 | 7 | 7 | 7 | 7 | 7 | 7 |
| Low mol. wt. oxidized polyethylene | | 1 | 1.27 | | | | | |
| homopolymer #1 (density = 0.99 g/cc) | | | | | | | | |
| Glycidyl compound | | 1 | 0.73 | 2 | | | | |
| Polyphosphoric acid | | 0.27 | 0.27 | 0.27 | | | 0.17 | 0.17 |
| Low mol. wt. polyethylene | | | | | 2 | | | |
| homopolymer #1, (density = 0.93 g/cc) | | | | | | | | |
| Low mol. wt. oxidized polyethylene | | | | | | | | |
| homopolymer #2 (density = 0.96 g/cc) | | | | | | | | |
| Fischer-Tropsch wax | | | | | | 2 | | |
| High mol. wt. glycidyl composition #1 | | | | | | | 2 | |
| High mol. wt. glycidyl composition #2 | | | | | | | | 2 |
| Brooksfield Viscosity (cPs) | 135 | 1390 | 1750 | 3100 | 1480 | 1050 | 3810 | 9360 |
| G* sin(delta) (kPa) | 70 | 3.13 | 4.06 | 6.42 | 3.9 | 2.78 | 3.72 | 6.46 |
| G* sin(delta) (kPa) | 76 | 1.6 | 2.12 | 3.36 | 1.96 | 1.39 | 2.18 | 4.01 |
| Pass/fail temp | (° C.) | 80.2 | 82.9 | 87.2 | 81.9 | 78.9 | 84.7 | 93.5 |
| RTFO Residue | | | | | | | | |
| G* sin(delta) (kPa) | 70 | 8.14 | 9.18 | 15.63 | 9.42 | 6.09 | 7.24 | 11.24 |
| G* sin(delta) (kPa) | 76 | 4.12 | 4.87 | 8.56 | 4.41 | 2.78 | 4.29 | 7.21 |
| Pass/fail temp | (° C.) | 81.5 | 83.5 | 89.5 | 81.5 | 77.8 | 83.7 | 92 |
| MSCR on RTFO Residue | | | | | | | | |
| R 3.2 kPa (%) | 70 | 10.54 | 18.09 | 53.77 | 5.57 | 3.48 | 75.01 | 92.5 |
| Jnr 3.2 kPa | 70 | 0.9 | 0.7 | 0.5 | 0.87 | 1.48 | 0.19 | 0.03 |
| Jnr Diff. | 70 | 60.34 | 93.97 | 38.72 | 23.81 | 44.69 | 11.48 | N/A |
| MSCR on RTFO Residue | | | | | | | | |
| R 3.2 kPa (%) | 76 | 4 | 6.83 | 29.54 | 1.87 | 1.11 | 59.55 | 90.39 |
| Jnr 3.2 kPa | 76 | 2.1 | 1.7 | 0.5 | 2.14 | 3.69 | 0.52 | 0.06 |
| Jnr Diff. | 76 | 70.55 | 112.4 | 71.75 | 32.37 | 62.62 | 32.37 | N/A |
| Separation test | | | | | | | | |
| Softening point ° C. | Top | 65.1 | 65 | 70 | 62.8 | 66.6 | 104.1 | 74.9 |
| Softening point ° C. | Bottom | 65.6 | 62.7 | 68.7 | 66.2 | 102.8 | 69.7 | 78.5 |
| ABS (Difference (top-bottom)), ° C. | | 0.5 | 2.3 | 1.3 | 3.4 | 36.2 | 34.4 | 3.6 |
| PG | | 76 | 82 | 82 | 76 | 76 | 82 | 88 |
| PG-MSCR | | 70V, | 70V, | 70E, | 70V, | 70H, | 70E, | 70E, |
| | | 76S | 76S | 76V | 76S | 76S | 76V | 76E |

Part 3

| | Temp | | | | | | | |
|---|---|---|---|---|---|---|---|---|
| Component | (° C.) | #8 | #16 | #17 | #18 | #19 | #20 | #21 |
| Bitumen Grade NA PG64-22 | | 92 | 91 | 91 | 91 | 91 | 89.73 | 90 |
| Recycled plastic (low density polyethylene) | | 8 | 7 | 7 | 7 | 7 | 8 | 8 |
| Low mol. wt. oxidized polyethylene | | | | | | | | |
| homopolymer #1 (density = 0.99 g/cc) | | | | | | | | |
| Glycidyl compound | | | | | | | 2 | |
| Polyphosphoric acid | | | | | | | 0.27 | |
| Low mol. wt. polyethylene homopolymer | | | | | | | | 2 |
| #1 (density = 0.93 g/cc) | | | | | | | | |
| Low mol. wt. polyethylene | | | 2 | | | | | |
| homopolymer #2 (density = 0.92 g/cc) | | | | | | | | |
| Low mol. wt. polyethylene | | | | 2 | | | | |
| homopolymer #3 (density = 0.91 g/cc) | | | | | | | | |
| Fischer-Tropsch wax | | | | | | | | |
| High mol. wt. glycidyl composition #1 | | | | | | | | |
| High mol. wt. glycidyl composition #2 | | | | | | | | |
| Thermally degraded wax #1 (density = | | | | | 2 | | | |
| 0.91 g/cc) | | | | | | | | |
| Thermally degraded wax #2 (density = | | | | | | 2 | | |
| 0.95 g/cc) | | | | | | | | |
| Brooksfield Viscosity (cPs) | 135 | 1410 | 1580 | 1390 | 1480 | 1510 | 1380 | 2350 |
| G* sin(delta) (kPa) | 70 | 2.33 | 3.14 | 2.58 | 3.11 | 3.31 | 2.26 | 6.63 |
| G* sin(delta) (kPa) | 76 | 1.13 | 1.58 | 1.40 | 1.57 | 1.66 | 1.13 | 3.28 |
| Pass/fail temp | (° C.) | 77 | 80.0 | 78.8 | 80.0 | 80.4 | 77.1 | 86.1 |
| RTFO Residue | | | | | | | | |
| G* sin(delta) (kPa) | 70 | 6.13 | 8.25 | 7.76 | 8.20 | 7.20 | 7.22 | 12.29 |
| G* sin(delta) (kPa) | 76 | 2.82 | 3.83 | 3.57 | 3.86 | 3.38 | 3.61 | 5.77 |
| Pass/fail temp | (° C.) | 77.9 | 80.3 | 79.7 | 80.5 | 79.4 | 80.3 | 83.7 |
| MSCR on RTFO Residue | | | | | | | | |
| R 3.2 kPa (%) | 70 | 2.98 | 5.14 | 5.03 | 4.74 | 3.63 | 9.01 | 8.32 |
| Jnr 3.2 kPa | 70 | 1.8 | 1.04 | 1.06 | 1.06 | 1.19 | 1.11 | 0.59 |
| Jnr Diff. | 70 | 14.75 | 26.21 | 23.11 | 21.38 | 21.73 | 40.35 | 24.15 |
| MSCR on RTFO Residue | | | | | | | | |
| R 3.2 kPa (%) | 76 | 0.93 | 2.20 | 1.63 | 1.72 | 1.22 | 3.45 | 3.03 |
| Jnr 3.2 kPa | 76 | 3.4 | 2.49 | 2.64 | 2.54 | 2.79 | 2.74 | 1.47 |
| Jnr Diff. | 76 | 15.5 | 17.56 | 29.73 | 25.29 | 27.77 | 41.39 | 26.75 |
| Separation test | | | | | | | | |
| Softening point ° C. | Top | 88 | 63.1 | 60.2 | 60.9 | 63.7 | 107.0 | 68.2 |
| Softening point ° C. | Bottom | 63 | 65.0 | 64.1 | 64.3 | 62.5 | 57.3 | 67.5 |
| ABS (Difference (top-bottom)), ° C. | | 25 | 1.9 | 3.9 | 3.4 | 1.2 | 49.7 | 0.7 |
| PG | | 76 | 76 | 76 | 76 | 76 | 76 | 82 |
| PG-MSCR | | 70H, | 70H, | 70H, | 70H, | 70H, | 70H, | 70V. |
| | | 76S | 76S | 76S | 76S | 76S | 76S | 76H |

Composition provided in weight percent, based on a total weight of the binder composition. Low molecular weight high density oxidized polyethylene homopolymer had a weight average molecular weight of 8,000 to 9,000 Daltons using the conditions described above.
LMW oxidized PE homopolymer #1: Honeywell Titan ® 7686.
LMW oxidized PE homopolymer #2: EPOLENE ® EE-2 made by Westlake Chemical.
LMW PE homopolymer #1: Honeywell Titan ® 7205.
LMW PE homopolymer #2: Honeywell Titan ® 7467.
LMW PE homopolymer #3: Honeywell Titan ® 7287.
High mol. wt. glycidyl composition #1 is Elvaloy ® 4170.
High mol. wt. glycidyl composition #2 is Lotader ® AX 8900.
Thermally degraded wax #1: AW115.91 made by GreenMantra Technologies.
Thermally degraded wax #2: 104N made by Lion Chemtech Co., Ltd.
Brookfield viscosity: ASTM D4402, Standard Test Method for Viscosity Determination of Asphalt at Elevated Temperatures Using a Rotational Viscometer.
G* (complex modulus), delta (phase angle): from ADTM D7175, Standard Test Method for Determining the Rheological Properties of Asphalt Binder Using a Dynamic Shear Rheometer; G*/sin(delta) can be calculated from G* and delta. A value of greater than or equal to 1.00 kiloPascals (kPa) is considered a passing value, at both 70 and 76° C.
RTFO (rolling thin-film oven) test: ASTM D2872, Standard Test Method for Effect of Heat and Air on a Moving Film of Asphalt (Rolling Thin-Film Oven Test) A value of greater than or equal to 2.20 kPa) is considered a passing value, at both 70 and 76°C.
MSCR (multiple stress creep and recovery) test: ASTM D7405, Standard Test Method for Multiple Stress Creep and Recovery (MSCR) of Asphalt Binder Using a Dynamic Shear Rheometer.
R3.2: average percentage recovery at 3.2 kPa.
Jnr3.2: non-recoverable creep compliance at 3.2 kPa. A value of less than or equal to 4.50 kPa is considered a passing value, at both 70 and 76° C.
Jnr diff: difference in non-recoverable creep compliance between 0.100 kPa and 3.200 kPa.
Multiple Stress Creep Recovery (MSCR) test, with the methodology described in AASHTO T350-14 and the specification in AASHTO M332-14.
Separation test: ASTM D7173, Standard Practice for Determining the Separation Tendency of Polymer from Polymer Modified Asphalt.
Softening point test: ASTM D36, Standard Test Method for Softening Point of Bitumen (Ring-and-Ball Apparatus).
ABS (Difference (top-bottom)), in ° C. A value of less than or equal to 5° C. is considered passing.
PG: performance grade, AASHTO M320, Standard Specification for Performance-Graded Asphalt Binder.
NOTE:
A. Rows titled (Low Molecular Weight polyethylene Homopolymer #2; Low Molecular Weight polyethylene Homopolymer #3; Thermally degraded wax #1; and Thermally degraded wax #2) present in Table 1, part 3 all have values of zero (0) in Table 1, parts 1 and 2.
B. The Elvaloy ® 4170 has a melt flow index (MFI) of 8, and theLotader ® AX 8900 has an MFI of 6. Lotader ® AX8840 has an MFI of 5, and a molecular weight of 105,000. The MFI is often used to approximate molecular weight. The Lotader ® AX8840 is an ethylene and glycidyl methacrylate copolymer similar to Elvaloy ® 4170 and Lotader ® AX 8900. Therefore, based on the MFI values, it is clear the Elvaloy ® 4170 (High mol. wt. glycidyl composition #1) and the Lotader ® AX 8900 (High mol. wt. glycidyl composition #2) have molecular weights greater than the Glycidyl methacrylate copolymers used in the examples above. The reported molecular weight of Elvaloy ® 4710 is 68,205 Daltons, and the reported molecular weight of the Lotader ® AX8840 is 71,190 Daltons.

The examples above demonstrate that the binder may include the recycled plastic in an amount of from about 4 to about 8 weight percent, based on a total weight of the binder. However, the upper limit is not clearly established. The use of the performance enhancement additive enables incorporation of the recycled plastic in amounts of greater than 4 weight percent, where unstable binders were found at 4 weight percent or greater recycled plastic without the performance enhancement additives.

Table 2 shows 5 paving compositions that include bitumen and a high density polyethylene (HDPE), where the high density polyethylene is a recycled plastic that is melted into the binder. The results show HDPE and bitumen is unstable when the HDPE concentration is 4 weight percent or greater (based on the total weight of the binder) by itself, as indicated in the ABS difference (top to bottom), where HDPE concentrations of 4 weight percent or more have a top to bottom softening point difference of more than 5° C. These tests show the increased storage stability when the performance enhancement additive includes (1) low molecular weight oxidized polyethylene homopolymer (2) glycidyl compound and (3) polyphosphoric acid.

TABLE 2

| | Temp | | | | | |
|---|---|---|---|---|---|---|
| Composition | (° C.) | H0 | H1 | H2 | H3 | H12 |
| Bitumen, Grade | | 99 | 98 | 96 | 94 | 93.73 |
| NA PG64-22 | | | | | | |
| Recycled plastic | | 1 | 2 | 4 | 6 | 4 |
| (high density | | | | | | |
| polyethylene) | | | | | | |
| Low molecular | | | | | | 1 |
| weight oxidized | | | | | | |
| polyethylene | | | | | | |
| homopolymer | | | | | | |
| (high density) | | | | | | |
| glycidyl | | | | | | 1 |
| compound | | | | | | |
| Polyphosphoric | | | | | | 0.27 |
| acid | | | | | | |
| Brookfield | 135 | 730 | 760 | 1180 | 2590 | 1700 |
| Viscosity (cPs) | | | | | | |
| G*/sin(delta) | 70 | 1.29 | 1.30 | 2.11 | 5.57 | 5.14 |
| (kPa) | | | | | | |
| G*/sin(delta) ( | 76 | 0.64 | 0.64 | 1.03 | 2.72 | 2.64 |
| kPa) | | | | | | |
| Pass/fail temp. | (° C.) | 72.2 | 72.2 | 76.2 | 84.4 | 84.7 |
| RTFO Residue | | | | | | |
| G*/sin(delta) | 70 | 2.83 | 3.14 | 5.09 | 9.81 | 11.58 |
| (kPa) | | | | | | |
| G*/sin(delta) | 76 | 1.35 | 1.60 | 2.41 | 4.53 | 6.49 |
| (kPa) | | | | | | |
| Pass/fail temp. | (° C.) | 72.0 | 73.2 | 76.7 | 81.6 | 87.1 |
| MSCR on | | | | | | |
| RTFO Residue | | | | | | |
| R 3.2 kPa (%) | 70 | 1.31 | 0.90 | 1.96 | 5.55 | 19.63 |
| Jnr 3.2 kPa | 70 | 3.41 | 3.73 | 1.82 | 0.73 | 0.48 |
| Jnr Diff. | 70 | 10.39 | 8.30 | 9.95 | 4.57 | 48.68 |
| MSCR on | | | | | | |
| RTFO Residue | | | | | | |
| R 3.2 kPa (%) | 76 | 0.13 | 0.25 | 0.46 | 2.39 | 8.14 |
| Jnr 3.2 kPa | 76 | 7.58 | 7.46 | 3.92 | 1.66 | 1.33 |
| Jnr Diff. | 76 | 9.52 | 9.85 | 10.73 | 12.09 | 69.14 |
| Separation test | | | | | | |
| Softening | Top | 53.2 | 51.4 | 123.2 | 129.9 | 64.5 |
| point, ° C. | | | | | | |
| Softening | Bottom | 53.6 | 51.7 | 55.6 | 60.6 | 63.1 |
| point, ° C. | | | | | | |
| ABS | | 0.4 | 0.3 | 67.6 | 69.3 | 1.4 |
| (Difference (top- | | | | | | |
| bottom)), ° C. | | | | | | |
| PG | | 70 | 70 | 76 | 76 | 82 |
| PG-MSCR | | 70S | 70S | 70H, | 70V, | 70E, |
| | | | | 76S | 76H | 76H |

Composition provided in weight percent, based on a total weight of the binder composition. Brookfield viscosity: ASTM D4402, Standard Test Method for Viscosity Determination of Asphalt at Elevated Temperatures Using a Rotational Viscometer.
G* (complex modulus), delta (phase angle): from ADTM D7175, Standard Test Method for Determining the Rheological Properties of Asphalt Binder Using a Dynamic Shear Rheometer; G*/sin(delta) can be calculated from G* and delta. A value of greater than or equal to 1.00 kiloPascals (kPa) is considered a passing value.
RTFO (rolling thin-film oven) test: ASTM D2872, Standard Test Method for Effect of Heat and Air on a Moving Film of Asphalt (Rolling Thin-Film Oven Test) A value of greater than or equal to 2.20 kPa) is considered a passing value.
MSCR (multiple stress creep and recovery) test: ASTM D7405, Standard Test Method for Multiple Stress Creep and Recovery (MSCR) of Asphalt Binder Using a Dynamic Shear Rheometer.
R3.2: average percentage recovery at 3.2 kPa.
Jnr3.2: non-recoverable creep compliance at 3.2 kPa. A value of less than or equal to 4.50 kPa is considered a passing value, at both 70 and 76° C.
Jnr diff: difference in non-recoverable creep compliance between 0.100 kPa and 3.200 kPa.
Multiple Stress Creep Recovery (MSCR) test, with the methodology described in AASHTO T350-14 and the specification in AASHTO M332-14.
Separation test: ASTM D7173, Standard Practice for Determining the Separation Tendency of Polymer from Polymer Modified Asphalt.
Softening point test: ASTM D36, Standard Test Method for Softening Point of Bitumen (Ring-and-Ball Apparatus).
ABS (Difference (top-bottom)), in ° C. A value of less than or equal to 5° C. is considered passing.
PG: performance grade, AASHTO M320, Standard Specification for Performance-Graded Asphalt Binder.

Table 3 shows 5 paving compositions that include bitumen and a linear low density polyethylene (LLDPE), where the LLDPE is a recycled plastic that is melted into the binder. The results show LLDPE and bitumen is unstable when the LLDPE concentration is 2 weight percent or greater (based on the total weight of the binder) by itself, as indicated in the ABS difference (top to bottom), where LLDPE concentrations of 2 weight percent or more have a top to bottom softening point difference of more than 5° C. Furthermore, the Brooksfield viscosity and RTFO residue values are too low at concentrations of less than 2 weight percent. As such, the binder may be essentially free of LLDPE in an exemplary embodiment, such as having a concentration of about 1 weight percent or less, or about 0.5 weigh percent or less, or about 0.1 weight percent or less in various embodiments. However, the combination of LLDPE with other types of recycled plastic melted into the binder may produce a viable product.

TABLE 3

| | Temp | | | | | |
|---|---|---|---|---|---|---|
| Composition | (° C.) | LL4 | LL3 | LL2 | LL1 | LL6 |
| Bitumen, Grade | | 99 | 98 | 96 | 94 | 95.73 |
| NA PG64-22 | | | | | | |
| Recycled plastic | | 1 | 2 | 4 | 7 | 2 |
| (linear low | | | | | | |
| density | | | | | | |
| polyethylene) | | | | | | |
| Low molecular | | | | | | |
| weight oxidized | | | | | | |
| polyethylene | | | | | | |
| homopolymer | | | | | | |
| (high density) | | | | | | |
| glycidyl | | | | | | 2 |
| compound | | | | | | |
| Polyphosphoric | | | | | | 0.27 |
| acid | | | | | | |
| Brookfield | 135 | 580 | 910 | 990 | 1960 | 1860 |
| Viscosity (cPs) | | | | | | |
| G*/sin(delta) | 70 | 0.85 | 1.62 | 1.47 | 3.01 | 3.34 |
| (kPa) | | | | | | |
| G*/sin(delta) | 76 | 0.43 | 0.80 | 0.71 | 1.47 | 1.73 |
| (kPa) | | | | | | |
| Pass/fail temp. | (° C.) | 68.6 | 74.1 | 73.2 | 79.2 | 81.0 |
| RTFO Residue | | | | | | |
| G*/sin(delta) | 70 | 2.06 | 3.71 | 4.23 | 6.83 | 8.95 |
| (kPa) | | | | | | |
| G*/sin(delta) | 76 | 0.99 | 1.76 | 2.01 | 3.23 | 4.89 |
| (kPa) | | | | | | |
| Pass/fail temp. | (° C.) | 69.5 | 74.2 | 75.2 | 79.1 | 83.9 |
| MSCR on | | | | | | |
| RTFO Residue | | | | | | |
| R 3.2 kPa (%) | 70 | 0.36 | 1.55 | 1.39 | 2.84 | 32.99 |
| Jnr 3.2 kPa | 70 | 5.46 | 2.77 | 2.36 | 1.27 | 0.52 |
| Jnr Diff. | 70 | 11.68 | 13.26 | 14.7 | 21.1 | 36.55 |
| MSCR on | | | | | | |
| RTFO Residue | | | | | | |
| R 3.2 kPa (%) | 76 | NA | 0.34 | 0.35 | 1.06 | 14.36 |
| Jnr 3.2 kPa | 76 | 10.96 | 6.03 | 5.27 | 2.88 | 1.43 |
| Jnr Diff. | 76 | 11.65 | 13.69 | 15.28 | 21.14 | 50.04 |
| Separation test | | | | | | |
| Softening | Top | 49.9 | 77.0 | 105.0 | 107.8 | 66.3 |
| point, ° C. | | | | | | |
| Softening | Bottom | 50.8 | 56.0 | 54.3 | 61.0 | 64.3 |
| point, ° C. | | | | | | |
| ABS | | 0.9 | 21.0 | 50.7 | 46.8 | 2.0 |
| (Difference (top- | | | | | | |
| bottom)), ° C. | | | | | | |
| PG | | 64 | 70 | 70 | 76 | 76 |
| PG-MSCR | | NA | 70S | 70S | 70H, | 70V |
| | | | | | 76S | 76H |

Composition provided in weight percent, based on a total weight of the binder composition.
Brookfield viscosity: ASTM D4402, Standard Test Method for Viscosity Determination of Asphalt at Elevated Temperatures Using a Rotational Viscometer.
G* (complex modulus), delta (phase angle): from ADTM D7175, Standard Test Method for Determining the Rheological Properties of Asphalt Binder Using a Dynamic Shear Rheometer; G*/sin(delta) can be calculated from G* and delta. A value of greater than or equal to 1.00 kiloPascals (kPa) is considered a passing value.
RTFO (rolling thin-film oven) test: ASTM D2872, Standard Test Method for Effect of Heat and Air on a Moving Film of Asphalt (Rolling Thin-Film Oven Test) A value of greater than or equal to 2.20 kPa) is considered a passing value.
MSCR (multiple stress creep and recovery) test: ASTM D7405, Standard Test Method for Multiple Stress Creep and Recovery (MSCR) of Asphalt Binder Using a Dynamic Shear Rheometer.
R3.2: average percentage recovery at 3.2 kPa.
Jnr3.2: non-recoverable creep compliance at 3.2 kPa. A value of less than or equal to 4.50 kPa is considered a passing value, at both 70 and 76° C.
Jnr diff: difference in non-recoverable creep compliance between 0.100 kPa and 3.200 kPa.
Multiple Stress Creep Recovery (MSCR) test, with the methodology described in AASHTO T350-14 and the specification in AASHTO M332-14.
Separation test: ASTM D7173, Standard Practice for Determining the Separation Tendency of Polymer from Polymer Modified Asphalt.
Softening point test: ASTM D36, Standard Test Method for Softening Point of Bitumen (Ring-and-Ball Apparatus).
ABS (Difference (top-bottom)), in ° C. A value of less than or equal to 5° C. is considered passing.
PG: performance grade, AASHTO M320, Standard Specification for Performance-Graded Asphalt Binder.

Table 4 shows 9 paving compositions that demonstrate the benefits of using waste plastic to replace mineral aggregates with or without low molecular weight oxidized polyethylene homopolymer. Aggregate gradation and mix design are described above and shown in these Tables. “Control” is a typical gradation and mix design with 100% mineral aggregate. For Run #1 and #2, the large mineral aggregates sizes (20 mm, 10 mm and 6.3 mm) typically used were replaced with an equal volume of waste high density polyethylene pellets (5-6 mm). In these mixtures, the fine aggregate, waste high density polyethylene aggregate and filler were heated @ 120° C. for 2 hours, then a desired quantity of bitumen was added to the mixture which was mixed with the help of a trowel till the whole mixture becomes homogeneous (approx. 20 mins.). For Runs #3 and #4, the 20 mm size mineral aggregates typically used and half of the 10 mm size mineral aggregates typically used were replaced with an equal volume amount of waste high density polyethylene pellets (5-6 mm). The mineral aggregate of the remaining 10 mm, 6.3 mm aggregate, waste high density polyethylene aggregate and filler were heated @ 120° C. for 2 hours and then a desired quantity of bitumen was added to the mixture which was mixed with the help of trowel till the whole mixture becomes homogeneous (approx. 20 mins.) In Runs #7 and #8, the 6.3 mm aggregate was replaced with an equal volume amount of waste high density polyethylene pellets (5-6 mm). The mineral aggregate of 20 mm, 10 mm aggregate, waste high density polyethylene aggregate and filler were heated @ 120° C. for 2 hours and then a desired quantity of bitumen was added to the mixture which was mixed with the help of trowel till the whole mixture becomes homogeneous (approx. 20 mins.) In Runs #9 and #10, the 10 mm aggregate was replaced with an equal volume amount of waste high density polyethylene pellets (5-6 mm). The mineral aggregate of 20 mm, 6.3 mm aggregate, waste high density polyethylene aggregate and filler were heated @ 120° C. for 2 hours and then a desired quantity of bitumen was added to the mixture which was mixed with the help of trowel till the whole mixture becomes homogeneous (approx. 20 mins.)

All bitumen mixtures were compacted using a Marshall compactor for 75 blows on both sides. Compared to the “Control” paving composition, all paving compositions containing waste plastic pellets as aggregates have a lower density, which will help to produce lighter weight building material with multiple benefits, including: 1) less load demand for base layers to support paving materials made with these paving compositions; and 2) less fuel consumption when transporting paving materials made with these paving compositions. In addition, since the mineral aggregates were replaced with waste plastic pellets on a volume basis, and the mineral aggregates have a much higher density, the amount of bitumen used for the runs using waste plastic was much less than for the control. Overall the reduction of bitumen, the most expensive material in the control paving composition, ranges from 38% (no polyolefin)-45% (polyolefin) for runs #1 and #2; 17% (no polyolefin)-25% (polyolefin) for runs #3 and #4; 17% (no polyolefin)-26% (polyolefin) for runs #7 and #8; and 12% (no polyolefin)-21% (polyolefin) for runs #9 and #10. Not to be bound by theory, but it may be that the waste plastic aggregate has less porosity than the mineral aggregate, and so the bitumen that normally absorbs into the mineral aggregate pores is not absorbed into pores in the replacement waste plastic. As such, this bitumen that is not absorbed into pores is available to provide the structure and function of the bitumen in the paving compositions. Moreover, even with a lower density and reduced amount of bitumen for the paving compositions containing waste plastic pellet as aggregates, the paving compositions with waste plastic have comparable or even better performance that paving compositions with all mineral aggregates, as indicated by Marshall Stability data.

The binder was the same for all runs, with the exception that Runs #2, #4, #8, and #10 include 2 weight percent low molecular weight oxidized polyethylene homopolymer, based on the weight of the bitumen, and Runs #1, #3, #7, and #9 did not include any low molecular weight oxidized polyethylene homopolymer. Run #2, #4, #8, and #10 had a higher density and higher Marshall stability than Runs #1, #3, #7, and #9, respectively, which would result in better longevity of a road produced using the bitumen mixture with the low molecular weight oxidized polyethylene homopolymer. As can be seen in Runs #2, #4, #8, and #10, using the low molecular weight oxidized polyolefin, produces a paving composition with better properties and reduced bitumen content as well.

TABLE 4
Part 1

| Ingredients and test | | | | | |
|---|---|---|---|---|---|
| results | Control | Run #1 | Run #2 | Run #3 | Run #4 |
| 20 mm mineral | 10% | 0 | 0 | 0 | 0 |
| aggregates weight | | | | | |
| percent | | | | | |
| 10 mm mineral | 20% | 0 | 0 | 11.41% | 11.41% |
| aggregates weight | | | | | |
| percent | | | | | |
| 6.3 mm mineral | 28% | 0 | 0 | 31.93% | 31.93% |
| aggregates weight | | | | | |
| percent | | | | | |
| Waste high density | | 34.60% | 34.60% | 8.77% | 8.77% |
| polyethylene | | | | | |
| aggregate (5-6 mm) | | | | | |
| weight percent | | | | | |
| Fine mineral | 40% | 62.30% | 62.30% | 45.61% | 45.61% |
| aggregate (0.15- | | | | | |
| 4.75 mm) weight | | | | | |
| percent | | | | | |
| Filler (0.075-0.6 mm) | 2% | 3.10% | 3.10% | 2.28% | 2.28% |
| weight percent | | | | | |
| Total (aggregates + | 1250 | 771 | 771 | 1052.3 | 1052.3 |
| filler) weight (grams) | | | | | |
| Bitumen weight | 5.70% | 5.70% | 5.10% | 5.70% | 5.10% |
| percent (% of total | | | | | |
| (aggregates + filler) | | | | | |
| weight) | | | | | |
| Bitumen weight | 71.3 | 43.9 | 39.3 | 60.0 | 53.7 |
| (grams) | | | | | |
| Low molecular | | | 2.0% of | | 2.0% of |
| weight oxidized | | | bitumen | | bitumen |
| polyethylene | | | | | |
| homopolymer weight | | | | | |
| Marshall Stability | 10.40 | 10.81 | 15.02 | 9.71 | 11.30 |
| @60° C. in KN | | | | | |
| Density, g/cm**3 | 2.29 | 1.56 | 1.76 | 2.21 | 2.23 |
| Bitumen | | | 10% | | 10% |
| | | | reduced | | reduced |
| | | | bitumen | | bitumen |
| | | | dosage | | dosage |
| | | | w.r.t. | | w.r.t. |
| | | | Run #1. | | Run #3. |

Part 2

| Ingredients and test | | | | | |
|---|---|---|---|---|---|
| results | Control | Run #7 | Run #8 | Run #9 | Run #10 |
| 20 mm mineral | 10% | 12.02% | 12.02% | 12.02% | 12.02% |
| aggregates weight | | | | | |
| percent | | | | | |
| 10 mm mineral | 20% | 24.04% | 24.04% | 0.00% | 0.00% |
| aggregates weight | | | | | |
| percent | | | | | |
| 6.3 mm mineral | 28% | 0.00% | 0.00% | 33.65% | 33.65% |
| aggregates weight | | | | | |
| percent | | | | | |
| Waste high density | | 13.46% | 13.46% | 9.62% | 9.62% |
| polyethylene | | | | | |
| aggregate (5-6 mm) | | | | | |
| weight percent | | | | | |
| Fine mineral | 40% | 48.08% | 48.08% | 48.08% | 48.08% |
| aggregate (0.15- | | | | | |
| 4.75 mm) weight | | | | | |
| percent | | | | | |
| Filler (0.075-0.6 mm) | 2% | 2.40% | 2.40% | 2.40% | 2.40% |
| weight percent | | | | | |
| Total (aggregates + | 1250 | 1040 | 1040 | 1100 | 1100 |
| filler) weight (grams) | | | | | |
| Bitumen weight | 5.70% | 5.70% | 5.10% | 5.70% | 5.10% |
| percent (% of total | | | | | |
| (aggregates + filler) | | | | | |
| weight) | | | | | |
| Bitumen weight | 71.3 | 59.3 | 53.0 | 62.7 | 56.1 |
| (grams) | | | | | |
| Low molecular | | | 2.0% of | | 2.0% of |
| weight oxidized | | | bitumen | | bitumen |
| polyethylene | | | | | |
| homopolymer weight | | | | | |
| Marshall Stability | 10.40 | 17.11 | 17.22 | 9.14 | 12.80 |
| @60° C. in KN | | | | | |
| Density, g/cm**3 | 2.29 | 1.80 | 1.89 | 1.91 | 1.98 |
| Bitumen | | | 10% | | 10% |
| | | | reduced | | reduced |
| | | | bitumen | | bitumen |
| | | | dosage | | dosage |
| | | | w.r.t. | | w.r.t. |
| | | | Run #7. | | Run #9 |

Density is determined by ASTM D2726, Standard test method for bulk specific gravity and density of non-absorptive compacted bituminous mixtures.
Marshall Stability: ASTM D6927; Standard test method for Marshall stability and flow of asphalt mixtures.

The mix design of Runs #5 and #6 is provided in Table 5.

TABLE 5

| | | | | Total weight |
|---|---|---|---|---|
| | | Weight | | of coarse |
| Ingredients | Ratio | Taken | | Aggregates |
| 20 mm Aggregate | 10% | 125 | g | 725 g |
| 10 mm Aggregate | 20% | 250 | g | |
| 6.3 mm Aggregate | 28% | 350 | g | |
| Fine aggregate | 40% | 500 | g | |
| Filler | 2% | 25 | g | |
| Total weight | 100% | 1250 | g | |
| Shredded waste | 10% of Coarse | 72.5 | g | |
| plastic | Aggregates | | | |
| Low molecular weight | 2% of Bitumen | 1.45 | g | |
| oxidized polyethylene | (Run #5 only) | | | |
| homopolymer | | | | |
| Bitumen | 5.72% of total | 71.5 | g | |
| | mineral | | | |
| | aggregate weight | | | |

Table 6 shows the Marshall stability and voids filled with bitumen (VFB) for samples with and without the low molecular weight oxidized polyethylene homopolymer used as a performance enhancement additive when using the same mix design as in Table 5.

Run #5 in table 6 was prepared by heating the coarse mineral aggregates (20 mm, 10 mm, and 6.3 mm) @ 150-160° C. for 2 hours, then a desired quantity of shredded waste plastic and low molecular weight oxidized polyethylene (LMWPE) were added to the heated aggregates to coat the aggregates. Then filler and fine aggregate were added to the mixture and it was mixed until the whole mixture was @ 150-160° C. Then the bitumen @ 160° C. was added to the mixture and it was mixed until the mixture was homogenous. Then the mixture was transferred to a Marshall mold and was compacted using a Marshall compactor for 75 blows on both sides. Run #6 used the same process but without the LMWPE.

TABLE 6

| | | | | | Run #6 | |
|---|---|---|---|---|---|---|
| | | | Run #5 | Run #6 | duplicate | |
| | MORTH | Run #5 | duplicate | (without | (without | |
| Test | specs. | (with LMWPE) | (with LMWPE) | LMWPE) | LMWPE) | Remarks |
| Marshall | 9.0 Min | 11.14 | 11.22 | 10.40 | 10.32 | LMWPE provides |
| Stability | | | | | | better Marshall |
| @60º C., | | | | | | stability and load |
| in KN | | | | | | bearing capacity. |
| VFB, % | 65-75 | 73.59 | 72.60 | 70.50 | 69.16 | High VFB |
| | | | | | | provides better |
| | | | | | | compaction and |
| | | | | | | adhesion |

LMWPE - low molecular weight oxidized polyethylene.
Stability: ASTM D6927; Standard test method for Marshall stability and flow of asphalt mixtures.
VFB (voids filled with bitumen): ASTM D3203/AASHTO &269; Standard test method for percent air voids in compacted dense and open bituminous paving mixtures.

Table 7 shows test results when polyethylene terephthalate (PET) was utilized as the waste plastic. “Control” is a typical gradation and mix design with 100% mineral aggregate, as described and illustrated above. In Runs #11 and #12, the 6.3 mm aggregate was replaced with an equal volume amount of waste PET pellets (5-6 mm). The mineral aggregate of 20 mm, 10 mm aggregate, waste PET aggregate and filler were heated @ 120° C. for 2 hours and then a desired quantity of bitumen was added to the mixture which was mixed with the help of trowel till the whole mixture becomes homogeneous (approx. 20 mins.) As with the waste high density polyethylene waste plastic described above, the waste PET plastic allowed for the use of reduced bitumen, with acceptable Marshall Stability results. Also, the use of low molecular weight oxidized polyethylene homopolymer in the binder allowed for further reduction of the bitumen, as compared to run #11 with the same amount of waste PET but with no low molecular weight oxidized polyethylene homopolymer in the binder, and with an increased Marshall Stability.

TABLE 7

| Ingredients and test results | Control | Run #11 | Run #12 |
|---|---|---|---|
| 20 mm mineral aggregates weight percent | 10% | 12.02% | 12.02% |
| 10 mm mineral aggregates weight percent | 20% | 24.04% | 24.04% |
| 6.3 mm mineral aggregates weight percent | 28% | 0.00% | 0.00% |
| Waste polyethylene terephthalate aggregate | | 13.46% | 13.46% |
| (5-6 mm) weight percent | | | |
| Fine mineral aggregate (0.15-4.75 mm) | 40% | 48.08% | 48.08% |
| weight percent | | | |
| Filler (0.075-0.6 mm) weight percent | 2% | 2.40% | 2.40% |
| Total (aggregates + filler) weight (grams) | 1250 | 1040 | 1040 |
| Bitumen weight percent (% of total | 5.70% | 5.70% | 5.10% |
| (aggregates + filler) weight) | | | |
| Bitumen weight (grams) | 71.3 | 59.3 | 53.0 |
| Low molecular weight oxidized polyethylene | | | 2.0% of |
| homopolymer weight | | | bitumen |
| Marshall Stability @ 60° C. in KN | 10.40 | 10.00 | 10.50 |
| Density, g/cm**3 | 2.29 | 2.04 | 2.06 |
| Bitumen | | | 10% reduced bitumen |
| | | | dosage w.r.t. Run #11. |

| | | |
|---|---|---|
| comment | no replacement of | replace all 6.3 mm |
| | mineral aggregates | mineral aggregates |

Density is determined by ASTM D2726, Standard test method for bulk specific gravity and density of non-absorptive compacted bituminous mixtures.
Marshall Stability: ASTM D6927; Standard test method for Marshall stability and flow of asphalt mixtures.

Table 8 shows test results when polystyrene (PS) was utilized as the waste plastic. “Control” is a typical gradation and mix design with 100% mineral aggregate, as described and illustrated above. In Runs #13 and #14, the 6.3 mm aggregate was replaced with an equal volume amount of waste PS pellets (5-6 mm). The mineral aggregate of 20 mm, 10 mm aggregate, waste PS aggregate and filler were heated @ 120° C. for 2 hours and then a desired quantity of bitumen was added to the mixture which was mixed with the help of trowel till the whole mixture becomes homogeneous (approx. 20 mins.) As with the waste high density polyethylene plastic described above, the waste PS plastic allowed for the use of reduced bitumen, with acceptable Marshall Stability results. Also, the use of low molecular weight oxidized polyethylene homopolymer in the binder allowed for further reduction of the bitumen, as compared to run #13 with the same amount of waste PS but with no low molecular weight oxidized polyethylene homopolymer in the binder, and with an increased Marshall Stability. The use of low molecular weight oxidized polyethylene homopolymer in the binder made a very significant increase in the Marshall Stability when the waste PS plastic was utilized.

TABLE 8

| Ingredients and test results | Control | Run #13 | Run #14 |
|---|---|---|---|
| 20 mm mineral aggregates weight percent | 10% | 12.02% | 12.02% |
| 10 mm mineral aggregates weight percent | 20% | 24.04% | 24.04% |
| 6.3 mm mineral aggregates weight percent | 28% | 0.00% | 0.00% |
| Waste polystyrene aggregate (5-6 mm) | | 13.46% | 13.46% |
| weight percent | | | |
| Fine mineral aggregate (0.15-4.75 mm) | 40% | 48.08% | 48.08% |
| weight percent | | | |
| Filler (0.075-0.6 mm) weight percent | 2% | 2.40% | 2.40% |
| Total (aggregates + filler) weight (grams) | 1250 | 1040 | 1040 |
| Bitumen weight percent (% of total | 5.70% | 5.70% | 5.10% |
| (aggregates + filler) weight) | | | |
| Bitumen weight (grams) | 71.3 | 59.3 | 53.0 |
| Low molecular weight oxidized polyethylene | | | 2.0% of |
| homopolymer weight | | | bitumen |
| Marshall Stability @ 60° C. in KN | 10.40 | 9.48 | 11.50 |
| Density, g/cm**3 | 2.29 | 2.01 | 2.03 |
| Bitumen | | | 10% reduced bitumen |
| | | | dosage w.r.t. Run #13. |

Density is determined by ASTM D2726, Standard test method for bulk specific gravity and density of non-absorptive compacted bituminous mixtures.
Marshall Stability: ASTM D6927; Standard test method for Marshall stability and flow of asphalt mixtures.

As can be seen in the examples, the use of the low molecular weight oxidized polyethylene homopolymer allows for a reduced amount of bitumen in the paving composition. By adding the low molecular weight oxidized polyethylene homopolymer in an amount of from about 1 to about 3 weight percent, based on a total weight of the binder, the amount of binder in the paving composition can be reduced to an amount of about 5.5 weight percent of the paving composition, or about 5.1 weight percent of the paving composition, and still provide comparable performance relative to a comparable paving composition without the low molecular weight oxidized polyethylene homopolymer. The above examples also illustrate that waste plastic can be incorporated into the aggregate in an amount of from about 1 to at least about 13.5 weight percent, based on a total weight of the paving composition, and still provide an effective product. For example, the paving composition may include the waste plastic in an amount of from about 1 to about 15 weight percent and still provide an effective product. In an exemplary embodiment, the waste plastic utilized as aggregate may include one or more of high density polyethylene, polyethylene terephthalate, and/or polystyrene.

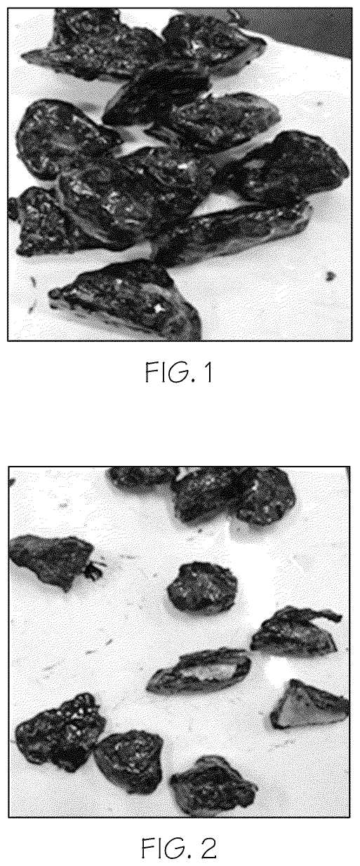

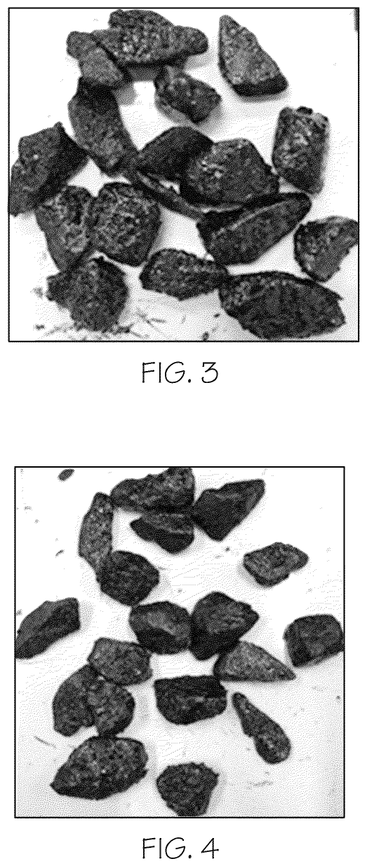

FIGS. 1 through 4 are photographs of mineral aggregate combined with 10 weight percent waste plastic (based on the weight of the aggregate) covered with a binder. In FIGS. 1 and 2, the binder was 100 weight percent bitumen, and in FIGS. 3 and 4 the 3 weight percent low molecular weight oxidized polyethylene, based on the total weight of the binder, was also added to the aggregate—waste plastic mixture. The aggregate was heated at 150° C. for 2 hours, whereupon 10 weight percent of shredded waste plastic by weight of the aggregate was added to the heated aggregate so that the shredded waste plastic should make an effective covering around the aggregate. The low molecular weight oxidized polyethylene, if used, was then added to the aggregate—waste plastic mixture. Then 5 weight percent bitumen, based on a total weight of the asphalt composition, was heated to 160° C. to get a desired flow, and was added to the aggregate/shredded waste plastic/low molecular weight oxidized polyethylene composition and was mixed to coat the aggregate with the bitumen. After that, the coated aggregate was left to equilibrate to room temperature, and then deionized water was added and it was kept in a water bath for 24 hours at 40° C. FIGS. 1 and 3 show the results for the samples without and with the low molecular weight oxidized polyethylene, respectively. Close inspection of FIGS. 1 and 3 show that the aggregate in FIG. 1 is not completely covered with the bitumen binder, but the aggregate in FIG. 3 is completely covered with bitumen binder.

Both samples (#2 and #4) were evaluated per ASTM D3625 for the boiling water test in which the specimens were kept in boiling water for 10 minutes, and then observed. FIGS. 2 and 4 show the aggregate after the boiling water test for the aggregate without and with the low molecular weight oxidized polyethylene, respectively. Close inspection of FIGS. 2 and 4 show the aggregate in FIG. 2 has significant portions with no bitumen coverage, but the aggregate in FIG. 4 is completely covered with bitumen.

These tests show the low molecular weight oxidized polyethylene increases the coverage of aggregate by the binder, as compared to a binder without the low molecular weight oxidized polyethylene.

While several embodiments have been presented in the foregoing detailed description, it should be appreciated that a vast number of variations exist. It should also be appreciated that the embodiment or embodiments are only examples, and are not intended to limit the scope, applicability, or configuration of this disclosure in any way. Rather, the foregoing detailed description will provide those skilled in the art with a convenient road map for implementing various embodiments of the asphalt compositions, it being understood that various changes may be made in the function and arrangement of elements described without departing from the scope as set forth in the appended claims and their legal equivalents.

What is claimed is:

1. A paving composition comprising:
a binder, wherein the binder comprises bitumen, recycled plastic, and a performance enhancement additive, wherein the performance enhancement additive is selected from the group of a low molecular weight polyolefin, a glycidyl compound, and a combination thereof, wherein the low molecular weight polyolefin has a weight average molecular weight of from about 500 to about 30,000 Daltons, wherein the glycidyl compound comprises an ethylene glycidyl (meth)acrylate polymer, and wherein the ethylene glycidyl (meth)acrylate polymer has a weight average molecular weight of from about 500 to about 30,000 Daltons.

2. The paving composition of claim 1, wherein the paving composition comprises the binder in an amount of about 1 to about 15 weight percent, based on a total weight of the paving composition; and
the paving composition further comprising an aggregate in an amount of from about 85 weight percent to about 99 weight percent, based on the total weight of the paving composition, wherein the aggregate is a solid material that may be differentiated from the binder by inspection.

3. The paving composition of claim 2, wherein the aggregate comprises from about 1 to 100 weight percent of waste plastic, based on a total weight of the aggregate, and wherein the waste plastic comprises one or more of polystyrene, polyolefin, polyethylene terephthalate, polyvinyl chloride, polymers made from ethylene propylene diene monomer, ethylene vinyl acetate, polyester, polytetrafluoroethylene, polyurethane, polycarbonates, polyamides, polyacrylamide, and polymethacrylamide.

4. The paving composition of claim 2, wherein the paving composition comprises the binder in an amount of from about 5.5 weight percent of less, based on the total weight of the paving composition.

5. The paving composition of claim 1, wherein the binder comprises the recycled plastic in an amount of from about 1 weight percent to about 20 weight percent, based on a total weight of the binder.

6. The paving composition of claim 1, wherein the recycled plastic comprises from about 90 weight percent to 100 weight percent polyethylene, based on a total weight of the recycled plastic.

7. The paving composition of claim 1, wherein the low molecular weight polyolefin is selected from the group of polyethylene, oxidized polyethylene with an acid number of from about 5 to about 40 mg KOH/gm, polypropylene, thermally degraded waxes, Fischer-Tropsch waxes, and combinations thereof, and the low molecular weight polyolefin is present in the binder in an amount of from 0.5 to about 5 weight percent, based on a total weight of the binder.

8. The paving composition of claim 1, wherein the performance enhancement additive comprises the glycidyl compound in an amount of from about 0.1 to about 5 weight percent, based on a total weight of the binder, and wherein the paving composition further comprises polyphosphoric acid in an amount of from about 0.1 to about 1 weight percent, based on the total weight of the binder.

9. The paving composition of claim 1, wherein the recycled plastic comprises linear low density polyethylene in an amount of from about 2 to about 4 weight percent, based on a total weight of the binder, and wherein the performance enhancement additive comprises the glycidyl compound and polyphosphoric acid.

10. The paving composition of claim 1, wherein the recycled plastic comprises high density polyethylene in an amount of from 4 to about 6 weight percent, based on a total weight of the binder, and the performance enhancement additive comprises the glycidyl compound and polyphosphoric acid.

11. A method for preparing a paving composition, the method comprising the steps of:
preparing a binder comprising a bitumen, a performance enhancement additive, and a recycled plastic, wherein the performance enhancement additive is melted into the binder, wherein the performance enhancement additive is selected from the group of a low molecular weight polyolefin, a glycidyl compound, and a combination thereof, wherein the low molecular weight polyolefin has a weight average molecular weight of from about 500 to about 30,000 Daltons, wherein the glycidyl compound comprises an ethylene glycidyl (meth)acrylate polymer having a weight average molecular weight of from about 500 to about 30,000 Daltons, and wherein the recycled plastic is melted into the binder; and
mixing the binder with an aggregate to produce the paving composition, wherein the aggregate is a solid material that may be differentiated from the binder by inspection.

12. The method of claim 11, wherein the aggregate comprises from about 1 to 100 weight percent of waste plastic, based on a total weight of the aggregate, and wherein the waste plastic comprises one or more of polystyrene, polyolefin, polyvinyl chloride, polymers made from ethylene propylene diene monomer, ethylene vinyl acetate, polyester, polytetrafluoroethylene, polyurethane, polycarbonates, polyamides, polyacrylamide, and polymethacrylamide.

13. The method of claim 11, wherein the recycled plastic comprises low density polyethylene such that the binder comprises from about 4 to about 8 weight percent low density polyethylene, based on a total weight of the binder.

14. The method of claim 11, wherein the performance enhancement additive is selected from the group of low molecular weight polyethylene, low molecular weight oxidized polyethylene with an acid number of from about 5 to about 40 mg KOH/gm, low molecular weight polypropylene, Fischer Tropsch waxes, thermally degraded waxes, maleated polypropylene, maleated polyethylene, ethylene vinyl acetate, ethylene acrylic acid, the glycidyl compound, polyphosphoric acid, and combinations thereof, and wherein the performance enhancement additive is added to the binder in an amount of from 0.1 to about 5 weight percent, based on a total weight of the binder.

15. The method of claim 11, wherein the binder has a top sample and a bottom sample, wherein the top sample and the bottom sample of the binder are provided by a separation test described by ASTM D7173, and wherein a top sample softening point and a bottom sample softening point have a difference of less than 5° C., as determined by a ring and ball softening point test, wherein the ring and ball softening point test is described by ASTM D36.

16. A paving composition comprising:
a binder in an amount of from about 1 to about 15 weight percent, based on a total weight of the paving composition, wherein the binder comprises bitumen;
an aggregate in an amount of from about 85 weight percent to about 99 weight percent, based on the total weight of the paving composition, wherein the aggregate is a solid material that can be differentiated from the binder by inspection, and wherein the aggregate comprises from about 1 to 100 weight percent waste plastic, based on a total weight of the aggregate; and
a performance enhancement additive, wherein the performance enhancement additive is selected from the group of a low molecular weight polyolefin, a glycidyl compound, and a combination thereof, wherein the low molecular weight polyolefin has a weight average molecular weight of from about 500 to about 30,000 Daltons, wherein the glycidyl compound comprises an ethylene glycidyl (meth)acrylate polymer, and wherein the ethylene glycidyl (meth)acrylate polymer has a weight average molecular weight of from about 500 to about 30,000 Daltons.

17. The paving composition of claim 16, wherein the binder comprises a recycled plastic in an amount of from about 1 weight percent to about 15 weight percent, based on a total weight of the binder, and wherein the recycled plastic comprises from about 90 weight percent to 100 weight percent polyethylene, based on a total weight of the recycled plastic.

18. The paving composition of claim 16, wherein the paving composition comprises the binder in an amount of from about 5.5 weight percent of less, based on the total weight of the paving composition.

19. The paving composition of claim 16, wherein the low molecular weight polyolefin is selected from the group of low molecular weight polyethylene, oxidized polyethylene with an acid number of from about 5 to about 40 mg KOH/gm, polypropylene, thermally degraded waxes, Fischer-Tropsch waxes, maleated polyethylene, maleated polypropylene, ethylene vinyl acetate, ethylene acrylic acid, and combinations thereof, and the low molecular weight polyolefin is present in the binder in an amount of from 0.5 to about 5 weight percent, based on a total weight of the binder.

20. The paving composition of claim 16, wherein the waste plastic comprises high density polyethylene, polyethylene terephthalate, polystyrene, or a combination thereof.
